(19) United States
(12) Patent Application Publication
(10) Pub. No.: US 2026/0052344 A1
(43) Pub. Date: Feb. 19, 2026

(54) TRANSDUCER ELEMENT AND ARRAY-TYPE TRANSDUCER WITH ORTHOGONAL DIAPHRAGM MOTION

(71) Applicant: WEGS Tech LLC, Dover, DE (US)

(72) Inventors: George Shaolin Wei, San Diego, CA (US); Enrique M Stiles, Redlands, CA (US)

(73) Assignee: WEGS Tech LLC, Dover, DE (US)

(21) Appl. No.: 19/299,055

(22) Filed: Aug. 13, 2025

(30) Foreign Application Priority Data
Aug. 13, 2024 (CN) 2024219516482

(51) Int. Cl. H04R 7/20; H04R 1/02; H04R 1/28; H04R 7/10

(52) U.S. Cl. CPC H04R 7/20; H04R 1/025; H04R 1/2896; H04R 7/10; H04R 2201/401; H04R 2207/021; H04R 2400/11

(57) ABSTRACT

A transducer element comprises an enclosure with a multi-walled frame, walls, and a planar diaphragm. The diaphragm is configured to generally move orthogonally with respect to the directly coupled pressure wave propagation, and it bisects the depth of the enclosure to form two independent acoustic chambers. The enclosure includes lids with ports, at least one port for each chamber. The lids are substantially perpendicular to the diaphragm and separated by the depth of the enclosure. The transducer element may be part of a transducer that utilizes multiple elements with similar designs to produce higher volume displacement, allowing for higher SPL output when used in loudspeaker applications. Additional planar diaphragms may also be present in each transducer element.

### CROSS-REFERENCE TO RELATED APPLICATIONS

This application claims priority to and benefit of Chinese Patent Application No. CN202421951648.2U, filed Aug. 13, 2024, now granted as CN223080135U, each of which is incorporated by reference herein in its entirety.

### TECHNICAL FIELD

The present utility model pertains to the field of speaker technology, specifically to a loudspeaker unit and an array-type loudspeaker.

### BACKGROUND TECHNOLOGY

Over the past nearly one hundred years, traditional speakers have generated sound through the actuation of voice coils within the working air gap.

With the rise of electromechanical and magnetostrictive materials, there has been increasing enthusiasm for developing piezoelectric speakers and magnetostrictive material speakers. However, due to the limitations of these materials' strain capabilities, miniaturized speakers based on such materials often struggle to meet the required sound pressure levels.

### SUMMARY OF THE INVENTION

The objective of the present utility model is to provide a loudspeaker unit and an array-type loudspeaker that simplify the structure of the speaker unit and enable the array-type loudspeaker to achieve sufficient amplitude while enhancing the sound pressure level in a miniaturized design.

To achieve this objective, in various embodiments, the present utility model employs the following technical solution:

The loudspeaker unit includes:
A closed-loop shell wall and a planar diaphragm (200). The cross-section of the closed-loop shell wall perpendicular to a first direction (also referred to as depth (D)) is a hollow closed-loop shape. The planar diaphragm (200) is located inside the closed-loop shell wall, with its thickness direction being a third direction (also referred to as width (W)), and the first direction and the third direction being perpendicular to each other. At least part of the edge of the planar diaphragm (200) is mounted on the closed-loop shell wall, and the planar diaphragm (200) divides the interior of the closed-loop shell wall into two mutually independent acoustic chambers: a first acoustic chamber (500) and a second acoustic chamber (600);
A first acoustic pressure guiding plate (300) and a second acoustic pressure guiding plate (400), both perpendicular to the first direction. The first acoustic pressure guiding plate (300) closes one end port of the first acoustic chamber (500) in the first direction, while the second acoustic pressure guiding plate (400) closes the other end port of the second acoustic chamber (600) in the first direction.

Optionally, the closed-loop shell wall includes a first frame end wall, a first cover plate, a second frame end wall, and a second cover plate connected end-to-end in sequence. The first frame end wall and the second frame end wall are arranged opposite each other in the second direction (also referred to as the length (L)), and the first cover plate and the second cover plate are located on both sides of the planar diaphragm (200) in the third direction. The first direction, the second direction, and the third direction are mutually perpendicular. The first frame end wall, the first cover plate, the second frame end wall, and the planar diaphragm (200) together form the first acoustic chamber (500), while the first frame end wall, the second cover plate, the second frame end wall, and the planar diaphragm (200) together form the second acoustic chamber (600).

Optionally, one end of the planar diaphragm (200) in the second direction is fixed to the first frame end wall (101), and in the direction from the first frame end wall (101) towards the second frame end wall (102), both the first cover plate (103) and the second cover plate (104) gradually move away from the planar diaphragm (200).

Optionally, the length direction of the planar diaphragm (200) is parallel to the second direction, and the width direction is parallel to the first direction.

Optionally, it also includes a flexible suspension edge (210), with the planar diaphragm (200) being connected to the second frame end wall (102) via the flexible suspension edge (210), and/or the planar diaphragm (200) being connected to the first acoustic pressure guiding plate (300) via the flexible suspension edge (210), and/or the planar diaphragm (200) being connected to the second acoustic pressure guiding plate (400) via the flexible suspension edge (210).

Optionally, a preset gap not exceeding 100 micrometers exists between the planar diaphragm (200) and the second frame end wall (102), and/or between the planar diaphragm (200) and the first acoustic pressure guiding plate (300), and/or between the planar diaphragm (200) and the second acoustic pressure guiding plate (400). In some embodiments the preset gap does not exceed 5%, 2%, 1%, or 0.1% of the width of the planar diaphragm. In some embodiments, the preset gap is a flexible compliant surround material.

Optionally, the closed-loop shell wall is a symmetric structure with respect to the central plane of the planar diaphragm (200).

Optionally, the planar diaphragm (200) includes an electromechanical layer, a magnetostrictive layer, or an electrostatic speaker layer. The planar diaphragm 200 may also be a piezoelectric bimorph.

An array-type loudspeaker includes multiple loudspeaker units as described above.

Optionally, the end plates of the loudspeaker units are sequentially fixedly connected in the third direction.

Optionally, multiple planar diaphragms may be present in each loudspeaker unit.

### Advantages of the Utility Model

The loudspeaker unit and array-type loudspeaker provided by the present embodiment use a planar diaphragm that directly interacts with air, simplifying the structure of the speaker unit, enhancing mechanical stability, and reducing audio distortion. At the same time, the planar diaphragm reduces the effective vibrating mass, thereby improving the sound pressure level. By designing the arrangement relationship between the planar diaphragm, the closed-loop shell wall, the first acoustic pressure guiding plate, and the second acoustic pressure guiding plate, the vibration direction of the planar diaphragm is perpendicular to the sound pressure output direction of the speaker unit. This helps to reduce the overall size after stacking multiple speaker units and significantly improves the sound pressure level of the array-type loudspeaker.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a structural schematic diagram of the planar diaphragm provided by the embodiment of the present utility model.

FIG. 2 is a structural schematic diagram of the planar diaphragm with a flexible suspension edge provided by the embodiment of the present utility model.

FIG. 3 is a structural schematic diagram of the loudspeaker unit provided by the embodiment of the present utility model.

FIG. 4 is a structural schematic diagram of the loudspeaker unit (with the first acoustic pressure guiding plate hidden) provided by the embodiment of the present utility model.

FIG. 5 is a structural schematic diagram of one embodiment of the array-type loudspeaker provided by the embodiment of the present utility model.

FIG. 6 is a structural schematic diagram of another embodiment of the array-type loudspeaker provided by the embodiment of the present utility model.

FIG. 7 illustrates a transducer element 700 in accordance with one embodiment.

FIG. 8 illustrates a transducer element 800 in accordance with one embodiment.

FIG. 9 illustrates a transducer element 900 in accordance with one embodiment.

FIG. 10A illustrates Negative Pressure Displacement 1000a accordance with one embodiment.

FIG. 10B illustrates Positive Pressure Displacement 1000b in accordance with one embodiment.

FIG. 11 illustrates a Prior Art Array 1100 in accordance with one embodiment.

FIG. 12 illustrates a Prior Art Array 1200 in accordance with one embodiment.

FIG. 13 illustrates a transducer element 1300 in accordance with one embodiment.

FIG. 14 illustrates a transducer element 1400 in accordance with one embodiment.

FIG. 15 illustrates negative pressure displacement 1500 in accordance with one embodiment.

FIG. 16 illustrates positive pressure displacement 1600 in accordance with one embodiment.

FIG. 17 illustrates linear array of transducer elements 1700 in accordance with one embodiment.

FIG. 18 illustrates a sectional view of a linear array of transducer elements 1800 in accordance with one embodiment.

FIG. 19 illustrates another sectional view of a linear array of transducer elements 1900 accordance with one embodiment.

FIG. 20 illustrates a circular array of transducer elements 2000 in accordance with one embodiment.

FIG. 21 illustrates a sectional view of a circular array of transducer elements 2100 in accordance with one embodiment.

FIG. 22 illustrates a transducer element 2200 in accordance with one embodiment.

FIG. 23A illustrates a negative pressure displacement 2300a in accordance with one embodiment.

FIG. 23B illustrates a positive pressure displacement 2300b in accordance with one embodiment.

FIG. 24 illustrates a transducer element 2400 in accordance with one embodiment.

FIG. 25A illustrates a positive pressure displacement 2500a in accordance with one embodiment.

FIG. 25B illustrates negative pressure displacement 2500b in accordance with one embodiment.

FIG. 26 illustrates a circular array of transducer elements 2600 in accordance with one embodiment.

FIG. 27 illustrates a sectional view of a circular array of transducer elements 2700 in accordance with one embodiment.

FIG. 28 illustrates a transducer element 2800 in accordance with one embodiment.

FIG. 29A illustrates a negative pressure displacement 2900a in accordance with one embodiment.

FIG. 29B illustrates a positive pressure displacement 2900b in accordance with one embodiment.

FIG. 30 illustrates a linear array comparison to the prior art 3000 in accordance with one embodiment.

FIG. 31 illustrates a sectional view of a linear array comparison of the prior art 3100 in accordance with one embodiment.

FIG. 32 illustrates another sectional view of a linear array comparison to the prior art 3200 in accordance with one embodiment.

FIG. 33 illustrates a transducer element 3300 in accordance with one embodiment.

FIG. 34A illustrates a negative pressure displacement 3400a in accordance with one embodiment.

FIG. 34B illustrates a positive pressure displacement 3400b in accordance with one embodiment.

FIG. 35 illustrates a transducer element 3500 in accordance with one embodiment.

FIG. 36A illustrates a positive pressure displacement 3600a in accordance with one embodiment.

FIG. 36B illustrates a negative pressure displacement 3600b in accordance with one embodiment.

FIG. 37 illustrates a transducer element 3700 in accordance with one embodiment.

FIG. 38A illustrates a negative pressure displacement 3800a in accordance with one embodiment.

FIG. 38B illustrates a positive pressure displacement 3800b in accordance with one embodiment.

FIG. 39 illustrates a transducer element 3900 in accordance with one embodiment.

### IN THE FIGURES

101 first frame end wall
102 second frame end wall
103 first cover plate
104 second cover plate
200 planar diaphragm
210 flexible suspension edge
300 first acoustic pressure guiding plate
400 second acoustic pressure guiding plate
500 first acoustic chamber
600 second acoustic chamber
502 frame
504 first port
506 second port
700 transducer element
702 enclosure
704 planar diaphragm
706 first port
708 second port
710 diaphragm attachment point
712 first frame end wall
714 second frame end wall
716 first frame side wall
718 second frame side wall
720 first acoustic chamber
722 second acoustic chamber
800 transducer element
802 planar diaphragm
804 diaphragm attachment point
806 first port
832 bottom lid
900 transducer element
902 planar diaphragm
904 diaphragm attachment point
908 second port
930 top lid
1000a negative pressure displacement
1000b positive pressure displacement
1002 planar diaphragm with negative displacement
1004 planar diaphragm with positive displacement
1006 diaphragm attachment point
1100 prior art array
1102 port
1104 planar diaphragm
1106 enclosure
1200 prior art array
1300 transducer element
1302 first planar diaphragm
1304 second planar diaphragm
1306 first port
1308 second port
1310 third port
1312 first diaphragm attachment point
1314 second diaphragm attachment point
1316 first frame end wall
1318 second frame end wall
1320 first frame side wall
1322 second frame side wall
1324 first acoustic chamber
1326 second acoustic chamber
1328 third acoustic chamber
1330 top lid
1332 bottom lid
1400 transducer element
1500 negative pressure displacement
1502 first planar diaphragm with negative displacement
1504 second planar diaphragm with negative displacement
1506 first planar diaphragm attachment point while under negative pressure displacement
1508 second planar diaphragm attachment point while under negative pressure displacement
1600 positive pressure displacement
1602 first planar diaphragm with positive displacement
1604 second planar diaphragm with positive displacement
1606 first planar diaphragm attachment point while under positive pressure displacement
1608 second planar diaphragm attachment point while under positive pressure displacement
1700 linear array of transducer elements
1702 enclosure
1704 first port
1706 second port
1708 third port
1710 top lid
1712 bottom lid
1800 sectional view of a linear array of transducer elements
1802 first planar diaphragm
1804 second planar diaphragm
1900 another sectional view of a linear array of transducer elements
2000 circular array of transducer elements
2002 enclosure
2004 first port
2006 second port
2008 third port
2010 first frame end wall
2012 second frame end wall
2100 sectional view of a circular array of transducer elements
2102 first planar diaphragm
2104 second planar diaphragm
2200 transducer element
2202 enclosure
2204 planar diaphragm
2206 first set of ports
2208 second set of ports
2210 flexible compliant diaphragm attachment point
2212 first frame end wall
2214 second frame end wall
2216 first frame side wall
2218 second frame side wall
2220 first acoustic chamber
2222 second acoustic chamber
2300a negative pressure displacement
2300b positive pressure displacement
2302 planar diaphragm in negative displacement
2304 planar diaphragm in positive displacement
2306 flexible compliant diaphragm attachment points
2400 transducer element
2402 enclosure
2404 first planar diaphragm
2406 second planar diaphragm
2408 first port
2410 second port
2412 third port
2414 flexible compliant diaphragm attachment points
2416 first frame end wall
2418 second frame end wall
2420 first frame side wall
2422 second frame side wall
2424 first acoustic chamber
2426 second acoustic chamber
2428 third acoustic chamber
2500a positive pressure displacement
2500b negative pressure displacement
2502 first planar diaphragm
2504 second planar diaphragm
2506 flexible compliant diaphragm attachment points
2600 circular array of transducer elements
2700 sectional view of a circular array of transducer elements
2800 transducer element
2802 enclosure
2804 planar diaphragm
2806 first port
2808 second port
2810 flexible compliant diaphragm attachment point
2812 first frame end wall
2814 second frame end wall
2816 first frame side wall
2818 second frame side wall
2820 first acoustic chamber
2822 second acoustic chamber
2900a negative pressure displacement
2900b positive pressure displacement
2902 planar diaphragm in negative pressure displacement
2904 planar diaphragm in positive displacement
2906 flexible compliant diaphragm attachment point
3000 linear array comparison to the prior art
3002 prior art linear array
3004 disclosed linear array
3100 sectional view of a linear array comparison of the prior art
3102 prior art planar diaphragms
3104 disclosed planar diaphragms
3200 another sectional view of a linear array comparison to the prior art
3300 transducer element
3302 enclosure
3304 planar diaphragm
3306 first port
3308 second port
3310 diaphragm attachment point
3312 first frame end wall
3314 second frame end wall
3316 first frame side wall
3318 second frame side wall
3320 first acoustic chamber
3322 second acoustic chamber
3400a negative pressure displacement
3400b positive pressure displacement
3402 planar diaphragm in negative displacement
3404 planar diaphragm in positive displacement
3406 diaphragm attachment point
3500 transducer element
3502 enclosure
3504 first planar diaphragm
3506 second planar diaphragm
3508 first port
3510 second port
3512 third port
3514 diaphragm attachment point
3516 first frame end wall
3518 second frame end wall
3520 first frame side wall
3522 second frame side wall
3524 first acoustic chamber
3526 second acoustic chamber
3528 third acoustic chamber
3600a positive pressure displacement
3600b negative pressure displacement
3602 first planar diaphragm
3604 second planar diaphragm
3606 diaphragm attachment points
3700 transducer element
3702 enclosure
3704 planar diaphragm
3706 first port
3708 second port
3710 flexible compliant diaphragm attachment point
3712 first frame end wall
3714 second frame end wall
3716 first frame side wall
3718 second frame side wall
3720 first acoustic chamber
3722 second acoustic chamber
3800a negative pressure displacement
3800b positive pressure displacement
3802 planar diaphragm
3804 flexible compliant diaphragm attachment points
3900 transducer element

### DETAILED DESCRIPTION

The following is a more detailed description of the present utility model with reference to the drawings and embodiments. It should be understood that the specific embodiments described here are intended to illustrate the present utility model and are not meant to limit its scope. Additionally, it should be noted that for ease of description, the drawings show only the parts relevant to the present utility model, not the entire structure.

In the description of the present utility model, unless otherwise explicitly specified, the terms “connected,” “joining,” and “fixed” should be understood in a broad sense. For example, they may refer to fixed connections, detachable connections, or integral structures; they may refer to mechanical connections or electrical connections; they may refer to direct connections or indirect connections via intermediate media; or they may refer to internal communication between two components or the interaction between two components. For those skilled in the art, the specific meaning of these terms in the present utility model can be understood based on the context.

In the description of the present utility model, unless otherwise explicitly specified, the term “on” or “above” with respect to a second feature may include both direct contact between the first and second features as well as indirect contact through additional features between them. Similarly, “below,” “under,” or “beneath” with respect to a second feature may include both direct contact and indirect contact through additional features. Moreover, “above,” “over,” and “on top of” indicate that the first feature is either directly above or obliquely above the second feature, or simply that the first feature is at a higher horizontal level compared to the second feature. Conversely, “below,” “under,” and “beneath” indicate that the first feature is either directly below or obliquely below the second feature, or simply that the first feature is at a lower horizontal level compared to the second feature.

In the description of the present embodiment, terms such as “up,” “down,” “right,” and other positional or directional references are based on the orientations or positional relationships shown in the drawings. They are provided for case of description and simplification of operation, and are not intended to indicate or imply that the described device or component must have a specific orientation or be constructed and operated in a specific manner. Therefore, they should not be construed as limitations on the present utility model. Additionally, the terms “first” and “second” are used merely for distinction in description and do not imply any special significance.

Various embodiments of this disclosure are generally directed to transducers and transducer elements. Some embodiments of the invention may be used for various components, such as audio components (i.e., loudspeakers, microphones) as well as in equipment for sonar operations, ultrasound transducers, transducers in medical imaging, transducers in welding equipment, air and hydraulic pressure sensors, but is not limited thereto.

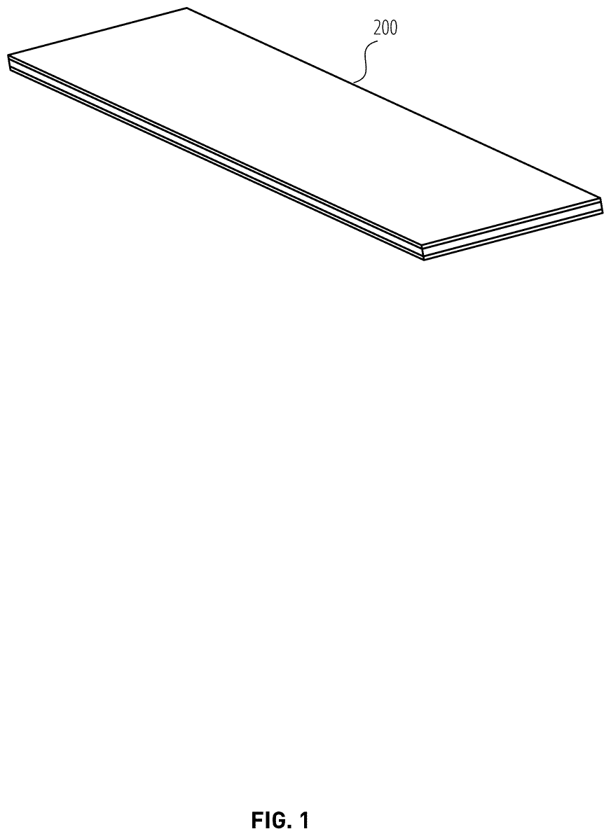

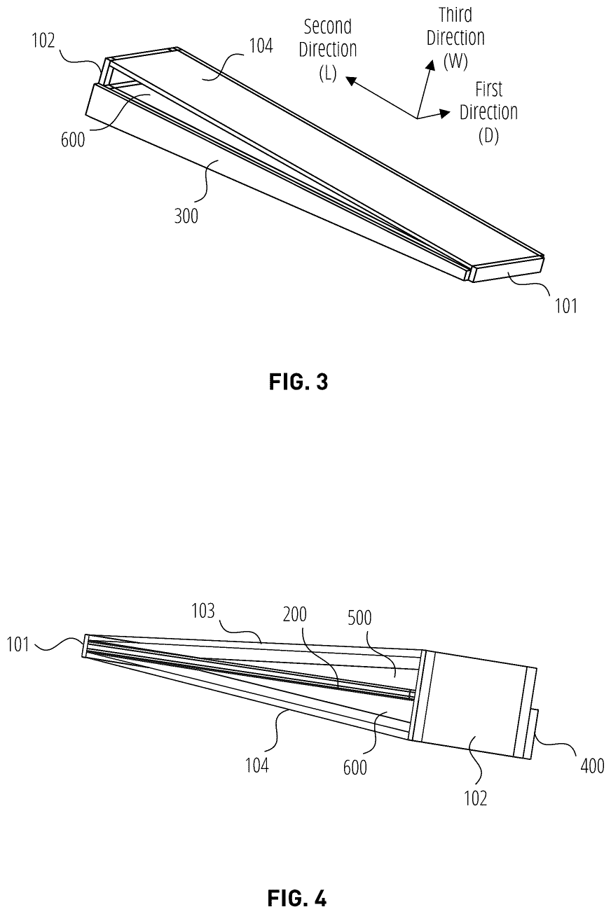

As shown in FIG. 1 to FIG. 5, the present embodiment provides a loudspeaker unit and an array-type loudspeaker, which includes multiple loudspeaker units. The loudspeaker unit comprises a closed-loop shell wall, a planar diaphragm 200, a first acoustic pressure guiding plate 300, and a second acoustic pressure guiding plate 400. The planar diaphragm 200 has positive and negative poles and vibrates to produce sound when subjected to an audio signal.

In the loudspeaker unit, the cross-section of the closed-loop shell wall perpendicular to a first direction is a hollow closed-loop shape. The planar diaphragm 200 is located inside the closed-loop shell wall, with its thickness direction being a third direction, and the first direction and the third direction being perpendicular to each other. At least part of the edge of the planar diaphragm 200 is mounted on the closed-loop shell wall. The planar diaphragm 200 divides the interior of the closed-loop shell wall into two mutually independent acoustic chambers: a first acoustic chamber 500 and a second acoustic chamber 600. Both the first acoustic pressure guiding plate 300 and the second acoustic pressure guiding plate 400 are perpendicular to the first direction. The first acoustic pressure guiding plate 300 closes one end port of the first acoustic chamber 500 in the first direction, while the second acoustic pressure guiding plate 400 closes the other end port of the second acoustic chamber 600 in the first direction.

In operation, the loudspeaker unit provided by this embodiment causes the planar diaphragm 200 to vibrate primarily along its thickness direction (the third direction) within the closed-loop shell wall. This vibration generates sound pressure along the third direction in both the first acoustic chamber 500 and the second acoustic chamber 600, located on either side of the planar diaphragm 200. The closed-loop shell wall, together with the first acoustic pressure guiding plate 300, redirects the sound pressure from the first acoustic chamber 500 by 90°, causing the sound pressure to be emitted along the first direction from the open end port of the first acoustic chamber 500. Similarly, the closed-loop shell wall, along with the second acoustic pressure guiding plate 400, redirects the sound pressure from the second acoustic chamber 600 by 90°, causing the sound pressure to be emitted along the first direction from the open end port of the second acoustic chamber 600. The output directions of the first acoustic chamber 500 and the second acoustic chamber 600 are opposite each other and both are perpendicular to the primary vibration direction of the planar diaphragm 200 (the third direction).

The use of planar diaphragm 200 serves as both a vibrating body and a sound pressure radiating body, interacting directly with the air. This configuration simplifies the structure of the loudspeaker unit, enhances mechanical stability, and reduces audio distortion. Additionally, the planar diaphragm 200 reduces effective vibrating mass, thereby increasing sound pressure level. By designing the arrangement relationships between the planar diaphragm 200, the closed-loop shell wall, the first acoustic pressure guiding plate 300, and the second acoustic pressure guiding plate 400, the vibration direction of the planar diaphragm 200 is made perpendicular to the sound pressure output direction of the loudspeaker unit. This is known as Orthogonal Diaphragm Motion (ODM). This arrangement helps reduce the overall size of the stacked loudspeaker units and significantly improves the sound pressure level of the array-type loudspeaker.

Optionally, the closed-loop shell wall includes a first frame end wall 101, a first cover plate 103, a second frame end wall 102, and a second cover plate 104, sequentially connected end to end. The first frame end wall 101 and the second frame end wall 102 are arranged opposite each other in the second direction, while the first cover plate 103 and the second cover plate 104 are respectively located on either side of the planar diaphragm 200 in the third direction. The first direction, second direction, and third direction are all mutually perpendicular. The first frame end wall 101, first cover plate 103, second frame end wall 102, and planar diaphragm 200 together form the first acoustic chamber 500, while the first frame end wall 101, second cover plate 104, second frame end wall 102, and planar diaphragm 200 together form the second acoustic chamber 600. The structure of the closed-loop shell wall is simple. In this embodiment, the first frame end wall 101, second frame end wall 102, first cover plate 103, and second cover plate 104 are all flat plates, which facilitates compact stacking of the closed-loop shell walls and reduces the overall size of the array-type loudspeaker.

Optionally, the closed-loop shell wall has a symmetrical structure with the center plane of the planar diaphragm 200 as the axis of symmetry. This design makes the loudspeaker unit aesthetically pleasing and facilitates the stacking of multiple loudspeaker units.

Optionally, one end of the planar diaphragm 200 in the second direction is fixed to the first frame end wall 101. Moving from the first frame end wall 101 toward the second frame end wall 102, the first cover plate 103 and the second cover plate 104 gradually move away from the planar diaphragm 200. In other words, one end of the planar diaphragm 200 is fixed and has zero amplitude. Along the second direction, the amplitude of the planar diaphragm 200 gradually increases, and the distance between the first cover plate 103, the second cover plate 104, and the planar diaphragm 200 increases adaptively. This design allows the planar diaphragm 200 to fully utilize the vibrational space within the closed-loop shell wall, helping to reduce the volume of the closed-loop shell wall and consequently the volume of the loudspeaker unit and the array-type loudspeaker, achieving a miniaturized design. In this embodiment, because the first frame end wall 101 is extremely narrow, the cross-section of the closed-loop shell wall perpendicular to the first direction is approximately triangular, such as an isosceles triangle.

Optionally, the length direction of the planar diaphragm 200 is parallel to the second direction, and the width direction is parallel to the first direction. The amplitude of the planar diaphragm 200 increases gradually from zero along the length direction, which helps to enhance the sound pressure produced by the planar diaphragm 200.

In an illustrative embodiment, a transducer element includes an enclosure having a width, a depth, and a length, where the enclosure includes a frame that is uniform and solid along the width of the enclosure. The transducer element also includes a planar diaphragm, where the planar diaphragm is configured within the frame to move orthogonally with respect to a normal vector of sound pressure output exiting a first port and exiting a second port in an opposite phase. In some embodiments, at least a portion of at least one end of the planar diaphragm is coupled to an inner portion of the frame that is perpendicular to the length of the enclosure. In several embodiments, the planar diaphragm bisects the depth of the enclosure to form a first acoustic chamber and a second acoustic chamber, the first acoustic chamber and the second acoustic chamber being mutually independent. Additionally, the enclosure may include a first acoustic pressure guiding plate mounted a first side of the first acoustic chamber, the first port in fluid communication with the first acoustic chamber on a second side of the first acoustic chamber. Further, a second acoustic pressure guiding plate may be mounted a first side of the second acoustic chamber with a second port in fluid communication with the second acoustic chamber on a second side of the second side of the second acoustic chamber. In another embodiment, the first acoustic pressure guiding plate and the second acoustic pressure guiding plate are perpendicular to and separated by the width of the enclosure.

In some embodiments, the enclosure includes a first frame end wall and a second frame end wall perpendicular to and separated by the length of the enclosure, and a first cover plate and a second cover plate perpendicular to and separated by the depth of the enclosure. In an embodiment, the continuous cross-section of the enclosure is formed by the first frame end wall, the first cover plate, the second frame end wall, and the second cover plate connected end-to-end in sequence. In this embodiment, the first frame end wall, the first cover plate, the second frame end wall, and the planar diaphragm form the first acoustic chamber. Further, in another embodiment, the first frame end wall, the second cover plate, the second frame end wall, and the planar diaphragm together form the second acoustic chamber.

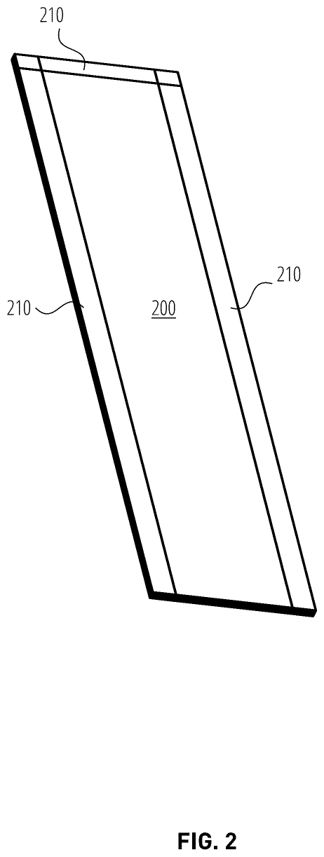

As shown in FIG. 2, in one embodiment, the loudspeaker unit also includes a flexible suspension edge 210. The planar diaphragm 200 is connected to the second frame end wall 102 via the flexible suspension edge 210, to the first acoustic pressure guiding plate 300 via the flexible suspension edge 210, and to the second acoustic pressure guiding plate 400 via the flexible suspension edge 210. The flexible suspension edge 210 is made from a relatively soft material. Specifically, the edge of the planar diaphragm 200 that is connected to the first frame end wall 101 is fixed, while the other edges are connected to the closed-loop shell wall and the first acoustic pressure guiding plate 300 via the flexible suspension edge 210. The flexible suspension edge 210 serves to adjust and control the vibration of the planar diaphragm 200, allowing it to produce the desired radiated sound waves. Additionally, it helps isolate the first acoustic chamber 500 and the second acoustic chamber 600 from each other along with the planar diaphragm 200. The flexible suspension edge 210 can be of various shapes, such as a folded type, planar type, or semi-circular type.

In another embodiment, a preset gap not exceeding 100 μm is provided between the planar diaphragm 200 and the second frame end wall 102, between the planar diaphragm 200 and the first acoustic pressure guiding plate 300, and between the planar diaphragm 200 and the second acoustic pressure guiding plate 400. A preset gap of up to 100 μm minimally impacts the isolation between the first acoustic chamber 500 and the second acoustic chamber 600. In some embodiments the preset gap does not exceed 5%, 2%, 1%, or 0.1% of the width of the planar diaphragm. In some embodiments, the preset gap is a flexible compliant surround material. Non-limiting examples of materials include natural rubber, synthetic rubbers, and other thermoplastic elastomers, such as Santoprene®.

Except for the edge connected to the first frame end wall 101, as shown in FIG. 1, the planar diaphragm 200 does not require a flexible suspension edge 210. The remaining edges of the planar diaphragm 200 can be free edges, which allows for larger amplitudes and eliminates the need for designing and manufacturing the flexible suspension edge 210. This makes it easier to implement in Micro-electromechanical systems (MEMS) micro-loudspeakers.

Optionally, the planar diaphragm 200 can include an electromechanical layer, a magnetostrictive layer, or an electrostatic sound layer. The electromechanical layer may be made from piezoelectric materials, the magnetostrictive layer may be made from magnetostrictive materials, and the electrostatic sound layer can use existing electrostatic speaker technologies. In several embodiments, the planar diaphragm 200 may be a piezoelectric bimorph. A bimorph is a cantilever used for actuation or sensing which consists of two active layers. It can also have a passive layer between the two active layers. In actuator applications, one active layer contracts and the other expands if voltage is applied, thus the bimorph bends.

Using these types of planar diaphragms 200 allows the loudspeaker unit to achieve sufficient amplitude while the planar diaphragm 200 directly interacts with the air, simplifying the speaker structure, enhancing mechanical stability, and reducing audio distortion.

When the planar diaphragm 200 includes an electromechanical layer or a magnetostrictive layer, some of its edges are fixed to the closed-loop shell wall, while the remaining edges are set with the aforementioned preset gaps or flexible suspension edge 210.

When the planar diaphragm 200 includes an electrostatic sound layer, all edges of the planar diaphragm 200 are fixedly connected to the closed-loop shell wall, the first acoustic pressure guiding plate 300, and the second acoustic pressure guiding plate 400.

Optionally, in an array loudspeaker, the end plates of the speaker units are sequentially fixed in the third direction. This compact stacking of speaker units facilitates the miniaturized design of the array loudspeaker.

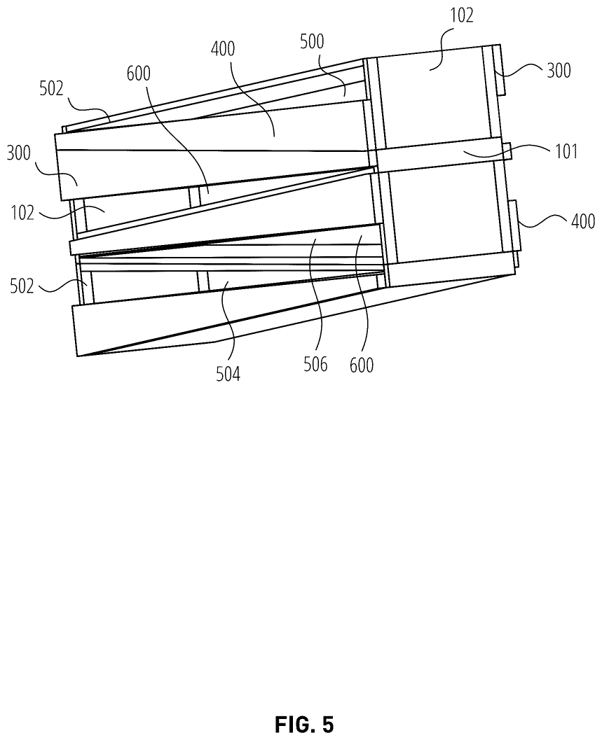

In one embodiment, the speaker units are stacked along the third direction. In adjacent speaker units, the first frame end wall 101 of one unit is fixedly connected to the second frame end wall 102 of the neighboring unit, forming a rectangular array loudspeaker. As shown in FIG. 5, a rectangular array loudspeaker formed by stacking six speaker units is compact in structure, with the sound pressure output direction located on both sides of the array loudspeaker in the first direction.

In an embodiment, an array-like loudspeaker may include a plurality of loudspeaker units, wherein each loudspeaker unit includes a transducer element comprising an enclosure having a width, a depth, and a length, where the enclosure includes a frame that is uniform and solid along the width of the enclosure. The transducer element also includes a planar diaphragm, where the planar diaphragm is configured within the frame to move orthogonally with respect to a normal vector of sound pressure output exiting a first port and exiting a second port in an opposite phase. In some embodiments, at least a portion of at least one end of the planar diaphragm is coupled to an inner portion of the frame that is perpendicular to the length of the enclosure. In several embodiments, the planar diaphragm bisects the depth of the enclosure to form a first acoustic chamber and a second acoustic chamber, the first acoustic chamber and the second acoustic chamber being mutually independent. Additionally, the enclosure may include a first acoustic pressure guiding plate mounted a first side of the first acoustic chamber, the first port in fluid communication with the first acoustic chamber on a second side of the first acoustic chamber. Further, a second acoustic pressure guiding plate may be mounted a first side of the second acoustic chamber with a second port in fluid communication with the second acoustic chamber on a second side of the second side of the second acoustic chamber. In another embodiment, the first acoustic pressure guiding plate and the second acoustic pressure guiding plate are perpendicular to and separated by the width of the enclosure.

In some embodiments of the array-like loudspeaker, the enclosure includes a first frame end wall and a second frame end wall perpendicular to and separated by the length of the enclosure, and a first cover plate and a second cover plate perpendicular to and separated by the depth of the enclosure. In an embodiment, the continuous cross-section of the enclosure is formed by the first frame end wall, the first cover plate, the second frame end wall, and the second cover plate connected end-to-end in sequence. In this embodiment, the first frame end wall, the first cover plate, the second frame end wall, and the planar diaphragm form the first acoustic chamber. Further, in another embodiment, the first frame end wall, the second cover plate, the second frame end wall, and the planar diaphragm together form the second acoustic chamber.

In some embodiments of the array-like loudspeaker, the first frame end walls and the second frame end walls of the transducer elements are sequentially fixedly connected along an edge of the first frame end walls and an edge of the second frame end walls.

In additional embodiments, the first frame end walls and the second frame end walls of the transducer elements are different heights in the depth dimension of the enclosure, thereby forming wedge shaped transducer elements.

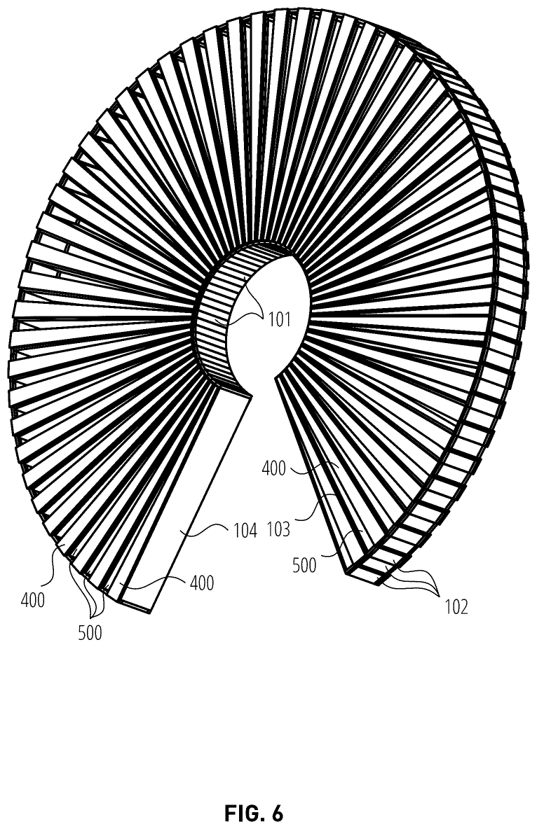

In another embodiment, as shown in FIG. 6, the speaker units are stacked along an arc direction. In adjacent speaker units, the first frame end wall 101 of one unit connects with the first frame end wall 101 of another unit, and the second frame end wall 102 of one unit connects with the second frame end wall 102 of another unit, forming a fan-shaped or circular array loudspeaker. The arrangement of the speaker units to form the array loudspeaker can be designed according to specific needs. The above embodiments are merely illustrative examples to clarify the present utility model and are not intended to limit the scope of the implementation of the present utility model.

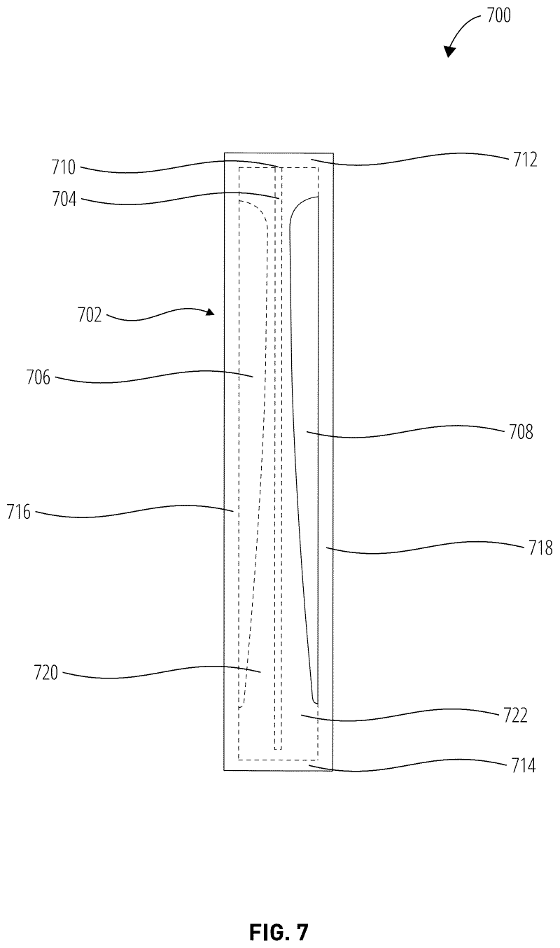

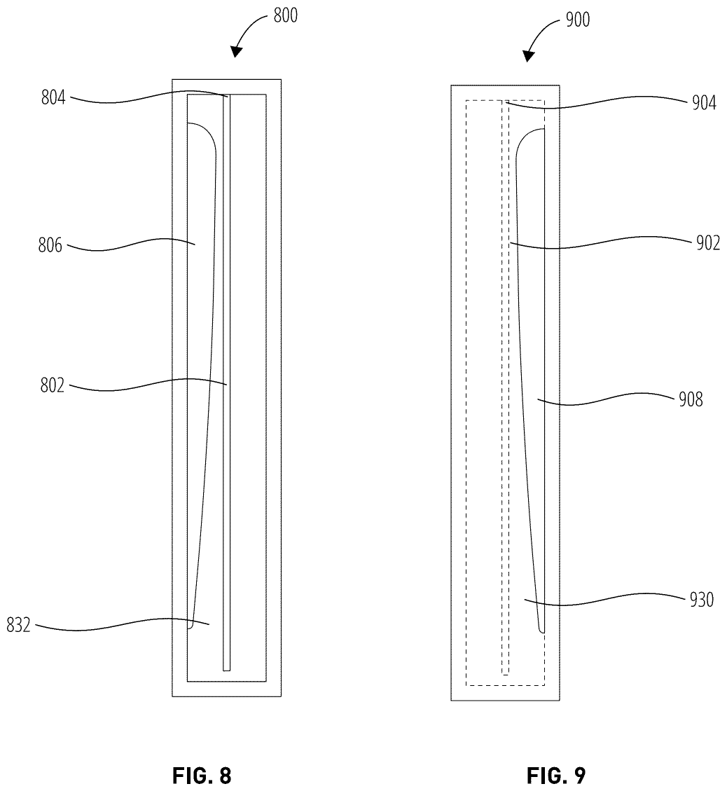

In some embodiments, as shown in FIG. 7 to FIG. 10A and FIG. 10B, a transducer element 700 includes an enclosure 702 comprising a multi-walled frame, a plurality of walls arranged to form the multi-walled frame, a top lid 930 and a bottom lid 832, where the enclosure 702 has a width, a depth, and a length. The top lid may also be referred to as a first acoustic pressure guiding plate and vice versa. The bottom lid may also be referred to as a second acoustic pressure guiding plate and vice versa. FIG. 7 is a transparent plan view with the top lid facing up and the bottom lid facing down. FIG. 8 is a plan view with the top lid removed and the bottom lid facing down. The transducer element also includes at least one planar diaphragm including a first planar diaphragm 704, where the at least one planar diaphragm is configured within the frame to move substantially orthogonally with respect to a normal vector of sound pressure output exiting a first port 706 and exiting a second port 708 in an opposite phase. The use of “generally” or “substantially” throughout the disclosure is meant to refer to a term of approximation and not a term of degree. In some embodiments, at least a portion of at least one end of the at least one planar diaphragm 704 is coupled to an inner portion of the frame that is substantially perpendicular to the length of the enclosure as seen in diaphragm attachment point 710. In some embodiments, the first planar diaphragm is configured within the frame and comprises a first end and a second end. In an illustrative embodiment, the at least one planar diaphragm divides the depth of the enclosure to form a first acoustic chamber 720 and a second acoustic chamber 722, the first acoustic chamber and the second acoustic chamber being mutually independent. In some embodiments, the top lid 930 is mounted perpendicular to the planar diaphragm 704 and includes the first port 706 in fluid communication with the first acoustic chamber 720. Additionally, the bottom lid 832 may be mounted perpendicular to the planar diaphragm 704 and includes the second port 708 in fluid communication with the second acoustic chamber. Further, the top lid 930 and the bottom lid 832 are separated by the depth of the frame.

In some embodiments, the plurality of walls may include a first frame end wall 712, a first frame side wall 716, a second frame end wall 714, and a second frame side wall 718. Additionally, at least a portion of at least one end of the first planar diaphragm 704 may be coupled to an inner portion of the frame that is perpendicular to the length of the enclosure and near the first frame end wall 712, and in a direction from the first frame end wall 712 towards the second frame end wall 714.

In some embodiments, the first frame end walls and the second frame end walls of the transducer element are different heights in the depth dimension of the enclosure, thereby forming a wedge shaped transducer element. In other embodiments, the first frame end walls and the second frame end walls of the transducer element are different heights in both the width dimension and the depth dimension of the enclosure, thereby forming a double wedge shaped transducer element.

In some embodiments, the frame may comprise individual walls that are attached together using, for example, butt joints including the first frame end wall, first frame side wall, and second frame side wall. Adjacent wall may be secured by welding, ultrasonic welding, adhesives, or mechanical fasteners such as screws. In exemplary embodiments, the frame may also be a solid extrusion of one or more pieces. Throughout the specification, individual walls may be referred to separately, but may also refer to a portion of the solid extrusion. In some embodiments, the frame is a multi-walled frame. In exemplary embodiments, the multi-walled frame is a rectangular shape or a wedge shape.

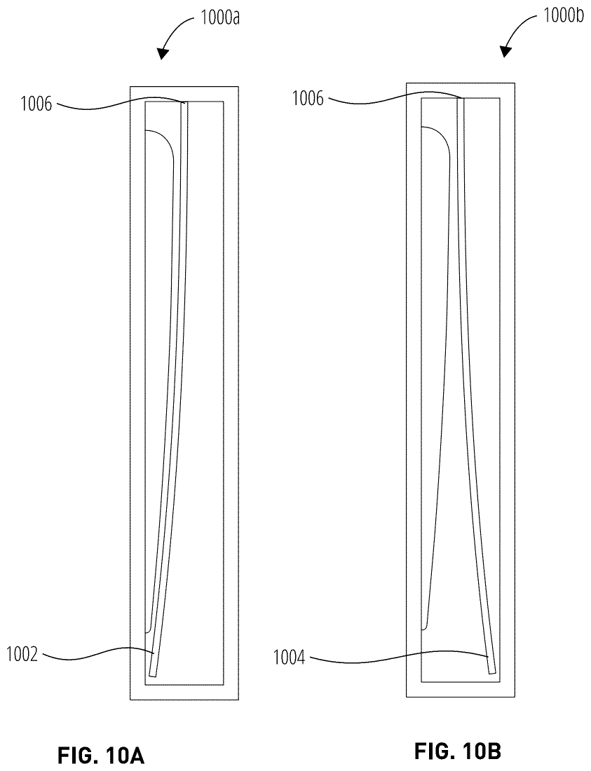

In some embodiments, FIG. 9 to FIG. 10A and FIG. 10B illustrate the movement of the planar diaphragm 902. FIG. 9 is a transparent plan view with the top lid facing up and the bottom lid removed. FIG. 10A and FIG. 10B are plan views with the top lid removed and the bottom lid facing down. The transducer element 900 includes a planar diaphragm 902, a diaphragm attachment point 904, a top lid 930, and a second port 908. The planar diaphragm 902 is shown with zero displacement where one end is secured at the diaphragm attachment point 904.

In an embodiment, FIG. 10A illustrates Negative Pressure Displacement 1000a, specifically for a planar diaphragm with negative displacement 1002. The maximum negative displacement of planar diaphragm 902 is shown with a diaphragm attachment point 1006 while under negative displacement.

In an embodiment, FIG. 10B illustrates Positive Pressure Displacement 1000b, specifically for a planar diaphragm with positive displacement 1004. The maximum positive displacement of planar diaphragm 902 is shown with a diaphragm attachment point 1006 while under positive displacement.

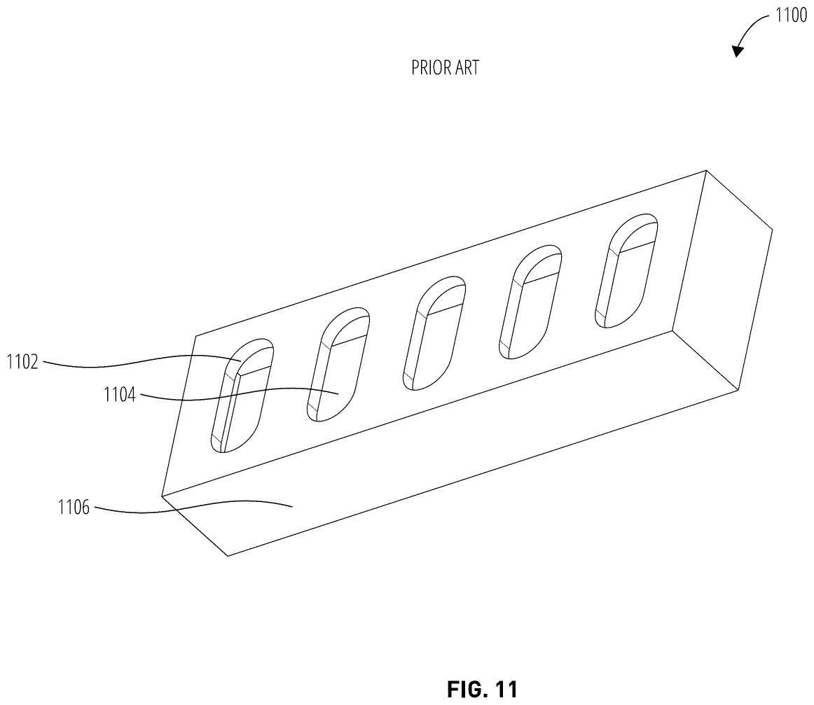

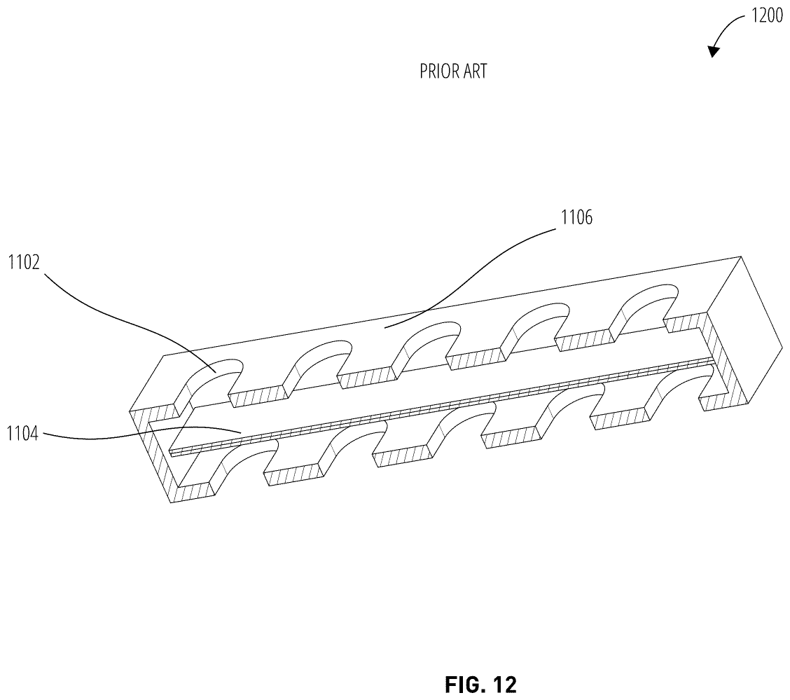

A Prior Art Array 1100 is illustrated in FIG. 11 and FIG. 12. The Prior Art Array 1100 may include an enclosure 1106, ports 1102, and a planar diaphragm 1104. A cross-section of the Prior Art Array 1200 illustrates that the planar diaphragm 1104 is mounted such that it moves parallelly to the vector of sound pressure output exiting the ports 1102.

The transducer element 1300 comprises a first planar diaphragm 1302, a second planar diaphragm 1304, a first port 1306, a second port 1308, a third port 1310, a first diaphragm attachment point 1312, a second diaphragm attachment point 1314, a first frame end wall 1316, a second frame end wall 1318, a first frame side wall 1320, a second frame side wall 1322, a first acoustic chamber 1324, a second acoustic chamber 1326, and a third acoustic chamber 1328.

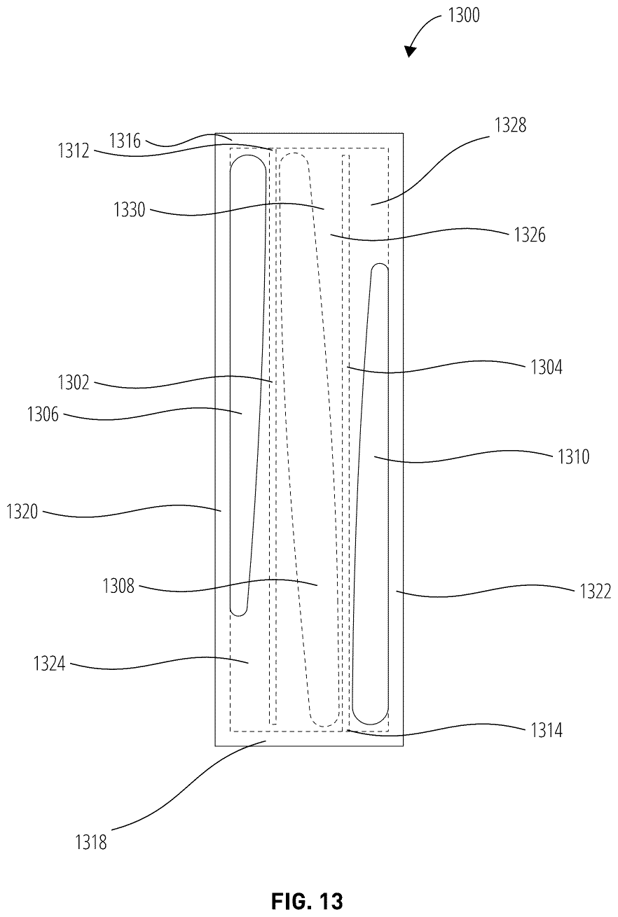

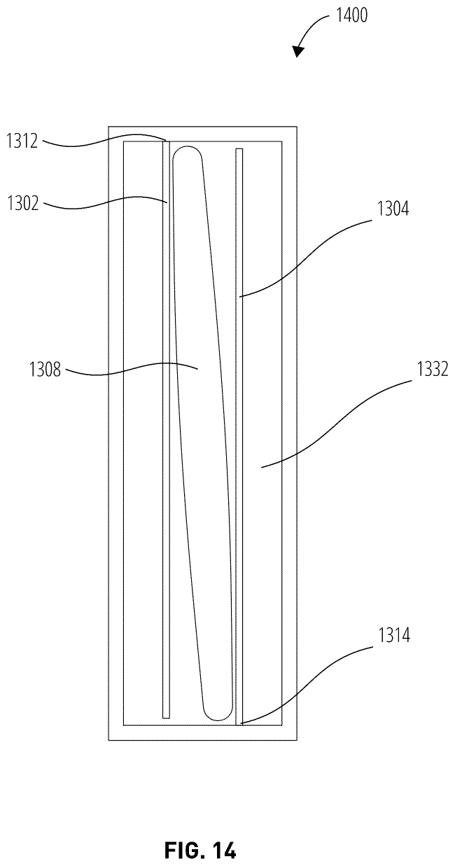

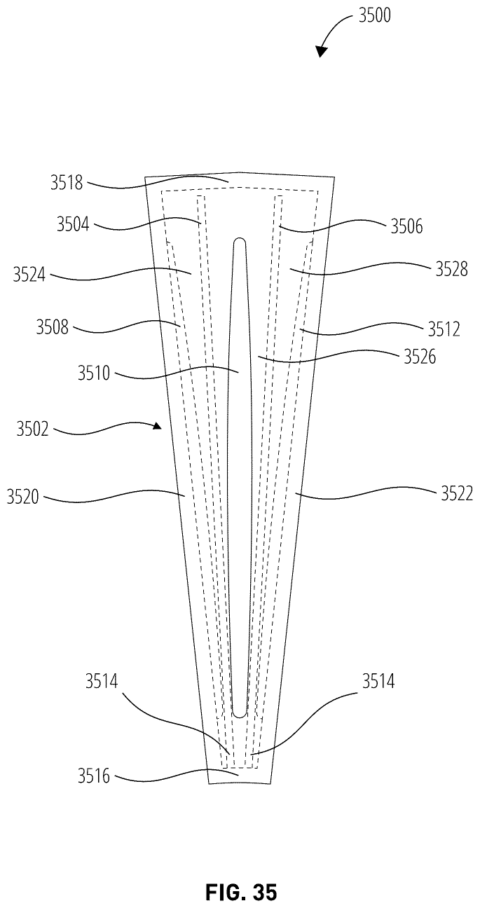

In addition to the features discussed above for the transducer element 700, a transducer element 1300 may include a second planar diaphragm 1304. FIG. 13 is a transparent plan view with the top lid facing up and the bottom lid facing down. FIG. 14 is a plan view with the top lid removed and the bottom lid facing down. As illustrated in FIG. 13 to FIG. 14, some embodiments of the transducer element 1300 may also include a second planar diaphragm 1304 and a third port 1310. The second planar diaphragm 1304 may be configured within the frame where at least a portion of at least one end of the second planar diaphragm is coupled to an inner portion of the frame at a second diaphragm attachment point 1314 that is perpendicular to the length of the enclosure and at an opposite end of the enclosure from a first diaphragm attachment point 1312 from the first end. In some embodiments, at least a portion of at least one end of the second planar diaphragm is coupled to an inner portion of the frame at a second diaphragm attachment point 1314 that is perpendicular to the length of the enclosure and at a same end of the enclosure from the first diaphragm attachment point 1312 (See FIG. 35). In some embodiments, the second planar diaphragm is configured within the frame and comprises a third end and a fourth end. In an embodiment, the first and second planar diaphragms divide the depth of the enclosure to form the first acoustic chamber 1324, the second acoustic chamber 1326, and a third acoustic chamber 1328 between the first and second planar diaphragms. In some embodiments, the first acoustic chamber 1324, second acoustic chamber 1326, and third acoustic chamber 1328 being mutually independent. In an illustrative embodiment, the top lid 1330 is mounted perpendicular to the first and second planar diaphragms and includes a first port 1306 in fluid communication with the first acoustic chamber 1324 and a third port 1310 in fluid communication with the second acoustic chamber 1326. In some embodiments, the bottom lid 1332 is mounted perpendicular to the first and second planar diaphragms and includes a second port 1308 in fluid communication with the third acoustic chamber 1328. In some embodiments, the top lid 1330 and the bottom lid 1332 are separated by the depth of the frame.

In some embodiments, the plurality of walls includes a first frame end wall 1316, a first frame side wall 1320, a second frame end wall 1318, and a second frame side wall 1322. In an embodiment, at least a portion of at least one end of the first planar diaphragm 1302 is coupled to an inner portion of the frame that is perpendicular to the length of the enclosure and near the first frame end wall 1316, and in the direction from the first frame end wall 1316 towards the second frame end wall 1318. Additionally, at least a portion of at least one end of the second planar diaphragm 1304 may be coupled to an inner portion of the frame that is perpendicular to the length of the enclosure and near the second frame end wall 1318 and in the direction from the second frame end wall 1318 towards the first frame end wall 1316.

In an embodiment, the first frame end walls 1316 and the second frame end walls 1318 of the transducer element 1300 are different heights in the depth dimension of the enclosure, thereby forming a wedge shaped transducer element.

In another embodiment, the transducer element 1300 including a first speaker element may additionally include at least one additional speaker element with the same configuration as the first speaker element. In an illustrative embodiment, the first frame end walls 1316 and the second frame end walls 1318 of the first speaker element and the at least one additional speaker element are sequentially fixedly connected along an edge of the first frame end walls 1316 and an edge of the second frame end walls 1318.

In another embodiment, the transducer element includes a first transducer element and further comprises a plurality of additional transducer elements with the same configuration as the first transducer element, wherein the first frame end walls and the second frame end walls of the first transducer element and the plurality of additional transducer elements are sequentially fixedly connected along an edge of the first frame end walls and an edge of the second frame end walls, resulting in a circular array of transducer elements.

FIG. 14 also illustrates first planar diaphragm 1302 and second planar diaphragm 1304 in a state where there is zero displacement in the portion above the first diaphragm attachment point 1312 and the second diaphragm attachment point 1314.

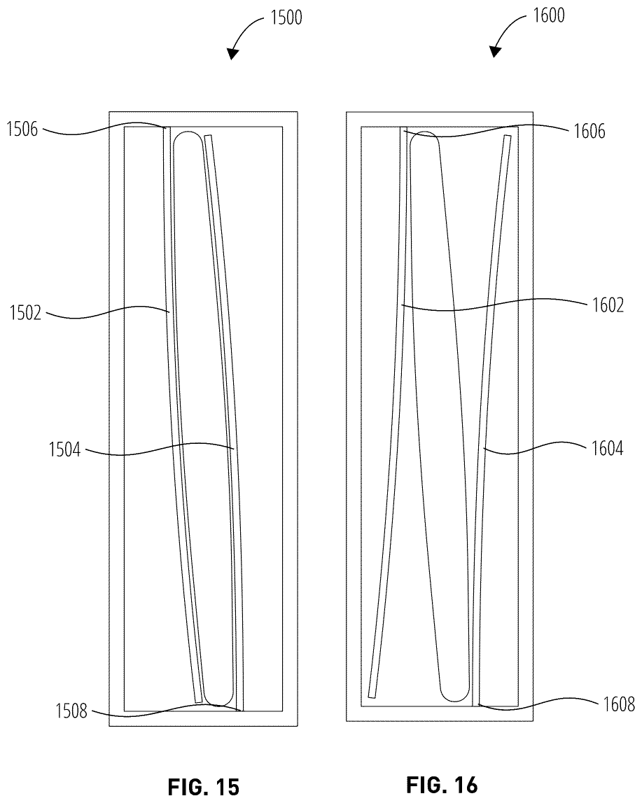

In an embodiment, FIG. 15 illustrates Negative pressure displacement 1500 for a first planar diaphragm with negative displacement 1502 and a second planar diaphragm with negative displacement 1504. The maximum negative displacements of first planar diaphragm 1302 and second planar diaphragm 1304 are shown with a first planar diaphragm attachment point while under negative pressure displacement 1506 and a second planar diaphragm attachment point while under negative pressure displacement 1508.

In an embodiment, FIG. 16 illustrates Positive pressure displacement 1600 for a first planar diaphragm with positive displacement 1602 and a second planar diaphragm with positive displacement 1604. The maximum positive displacements of first planar diaphragm 1302 and second planar diaphragm 1304 are shown with a first planar diaphragm attachment point while under positive pressure displacement 1606 and a second planar diaphragm attachment point while under positive pressure displacement 1608.

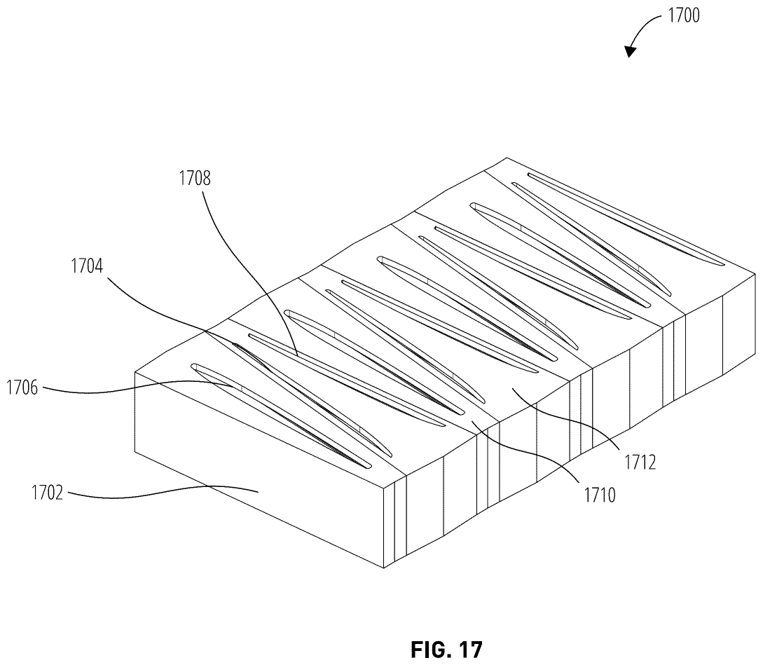

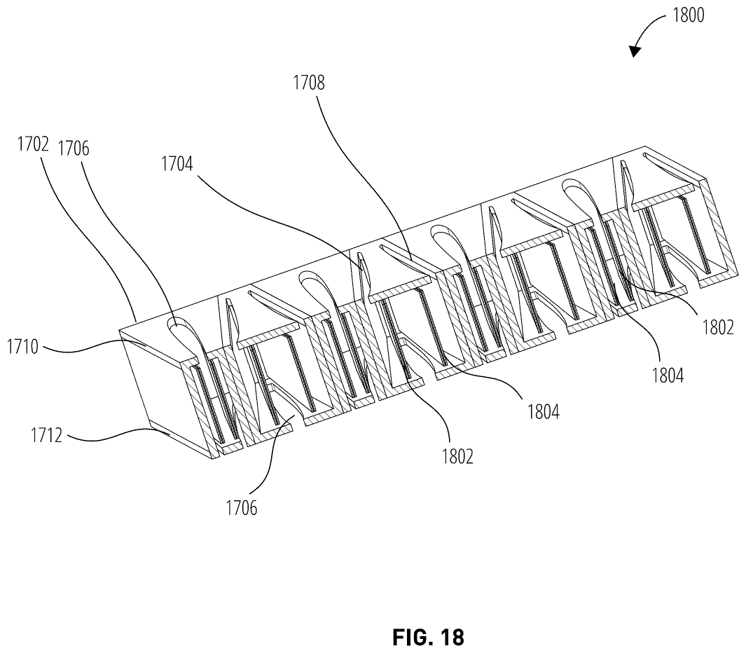

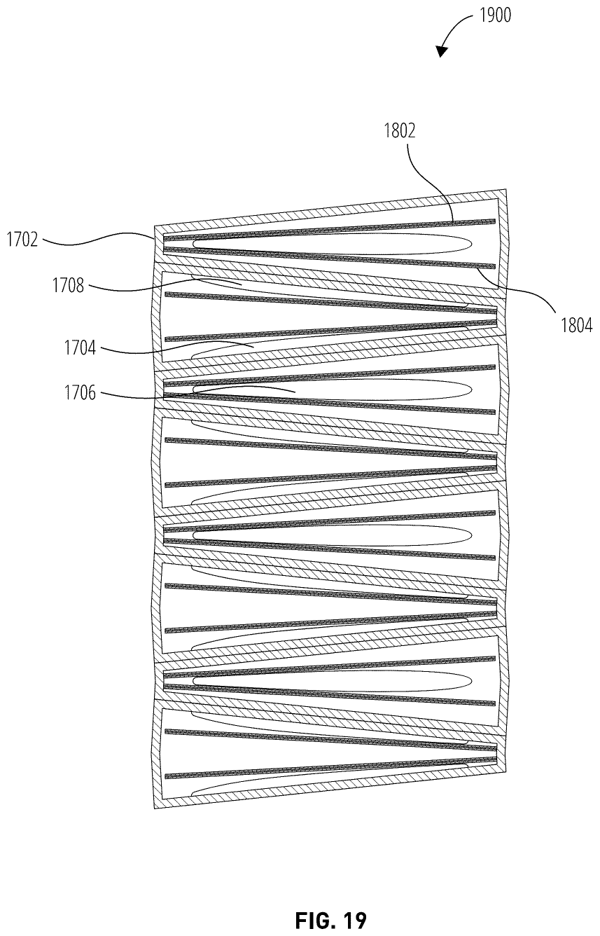

In some embodiments, FIG. 17 illustrates a linear array of transducer elements 1700 constructed with a plurality of transducer elements according to the embodiments above. The linear array of transducer elements 1700 includes transducer elements that have a wedge shape, but one of skill in the art would realize that other shapes may be used. An enclosure 1702 may include a first port 1704, a second port 1706, and a third port 1708. As illustrated in FIG. 18 and FIG. 19, cross-sectional views of the sectional view of a linear array of transducer elements 1800 and another sectional view of a linear array of transducer elements 1900 show a first planar diaphragm 1802, and a second planar diaphragm 1804, a top lid 1710 and a bottom lid 1712.

The circular array of transducer elements 2000 comprises an enclosure 2002, a first port 2004, a second port 2006, and a third port 2008.

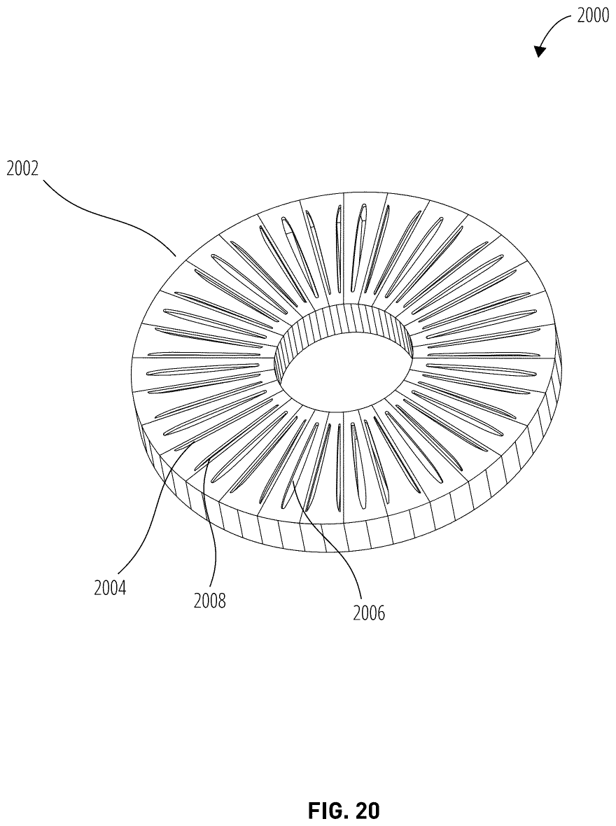

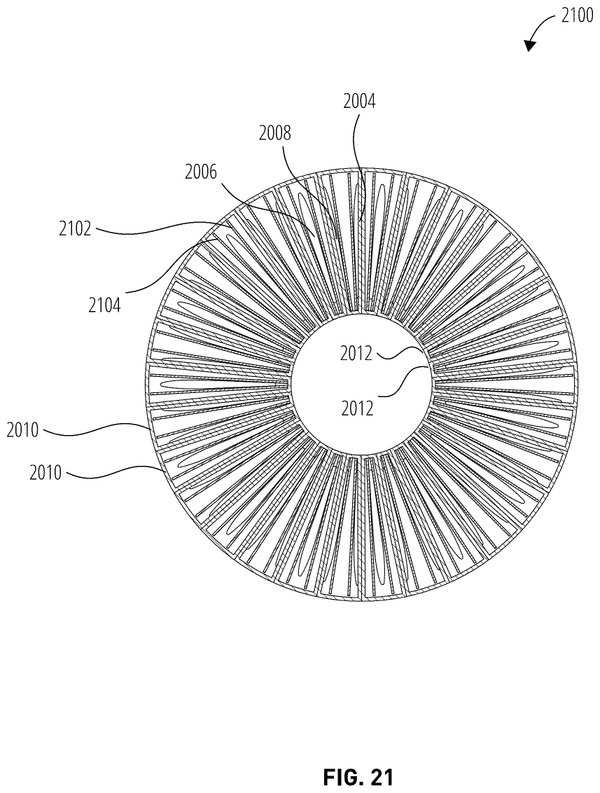

In some embodiments, FIG. 20 illustrates a circular array of transducer elements 2000 constructed with a plurality of transducer elements according to the embodiments above. The sectional view of a circular array of transducer elements 2100 includes a circular enclosure 2002, comprising transducer elements that have a wedge shape, but one of skill in the art would realize that other shapes may be used. As shown in FIG. 20 and FIG. 21, the transducer elements are stacked along an arc direction. In adjacent speaker units, the first frame end wall 2010 of one unit connects with the first frame end wall 2010 of another unit, and the second frame end wall 2012 of one unit connects with the second frame end wall 2012 of another unit, forming a fan-shaped or circular array loudspeaker. The enclosure 2002 may include a plurality of first ports 2004, second ports 2006, and third ports 2008. As illustrated in FIG. 21, a cross-sectional view of the sectional views of a circular array of transducer elements 2100 shows first planar diaphragms 2102, and second planar diaphragms 2104.

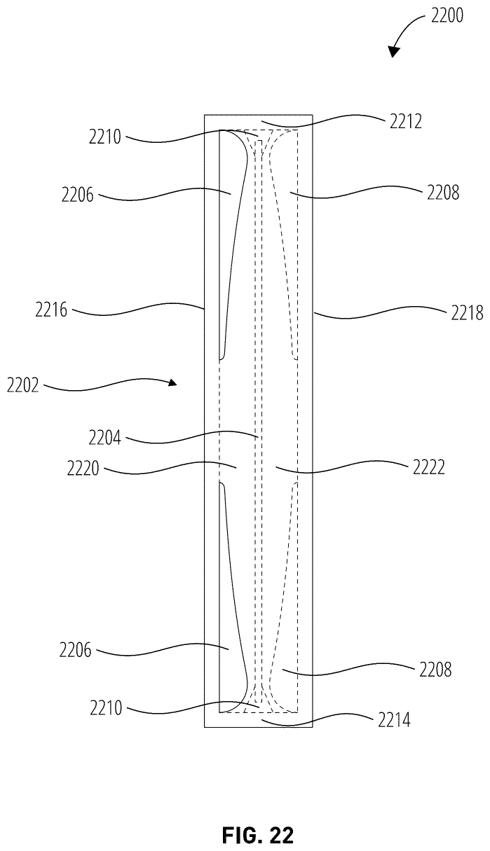

As shown in FIG. 22, a transducer element 2200 comprises an enclosure 2202, a planar diaphragm 2204, a first set of ports 2206, a second set of ports 2208, a flexible compliant diaphragm attachment point 2210, a first frame end wall 2212, a second frame end wall 2214, a first frame side wall 2216, a second frame side wall 2218, a first acoustic chamber 2220, and a second acoustic chamber 2222.

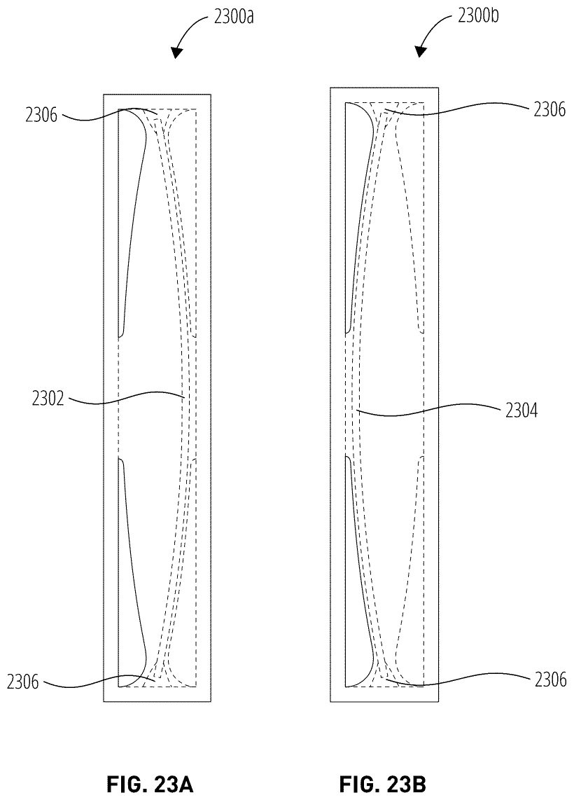

In addition to the features discussed above for the transducer element 700, a transducer element 2200 may include a planar diaphragm 2204 and two flexible compliant diaphragm attachment points 2210. FIG. 22 to FIG. 23B are transparent plan views with the top lid facing up and the bottom lid facing down. In some embodiments, as shown in FIG. 22 to FIG. 23B, a transducer element 2200 includes at least a portion of both ends of the planar diaphragm 2204 coupled to an inner portion of the frame that is perpendicular to the length of the enclosure as seen in flexible compliant diaphragm attachment points 2210. In an illustrative embodiment, this planar diaphragm 2204 divides the depth of the enclosure to form a first acoustic chamber 2220 and a second acoustic chamber 2222, the first acoustic chamber and the second acoustic chamber being mutually independent. In some embodiments, a top lid is mounted perpendicular to the planar diaphragm 2204 and includes the first set of ports 2206 in fluid communication with the first acoustic chamber 2220. Additionally, the bottom lid may be mounted perpendicular to the planar diaphragm 2204 and includes the second port 2410 in fluid communication with the second acoustic chamber. Further, the top lid and the bottom lid are separated by the depth of the frame.

In some embodiments, a plurality of walls may include a first frame end wall 2212, a first frame side wall 2216, a second frame end wall 2214, and a second frame side wall 2218. Additionally, at least a portion of one end of the planar diaphragm 2204 may be coupled to an inner portion of the frame that is perpendicular to the length of the enclosure and near the first frame end wall 2212, and at least a portion of the other end of the planar diaphragm 2204 may be coupled to an inner portion of the frame that is perpendicular to the length of the enclosure and near the first second frame end wall 2214.

In some embodiments, a planar diaphragm including a flexible compliant diaphragm attachment may be referred to as a dual-hinged end blade (DHE blade). In some embodiments, the flexible compliant diaphragm attachment may be made from natural or synthetic rubbers as well as other thermoplastic elastomers, such as Santoprene, or the like. In other embodiments, attachment to the diaphragm may be via adhesives, or mechanical fasteners such as screws. In exemplary embodiments, the flexible compliant diaphragm attachment may also be made by a thin flexible layer of plastic or metal, such as spring steel, that may further act an internal planar diaphragm substrate. In some embodiments, each of the first end and the second end of the planar diaphragm is compliantly coupled to the frame to function as a hinge.

In an embodiment, FIG. 23A illustrates negative pressure displacement 2300a, specifically for a planar diaphragm in negative displacement 2302 where the planar diaphragm is attached at each end with a flexible compliant diaphragm attachment. The maximum negative displacement of the planar diaphragm in negative displacement 2302 is shown with a flexible compliant diaphragm attachment points 2306 at each end while under negative displacement.

In an embodiment, FIG. 23B illustrates positive pressure displacement 2300b, specifically for a planar diaphragm with planar diaphragm in positive displacement 2304 where the planar diaphragm is attached at each end with a flexible compliant diaphragm attachment. The maximum positive displacement of the planar diaphragm in positive displacement 2304 is shown with a flexible compliant diaphragm attachment points 2306 at each end while under positive displacement.

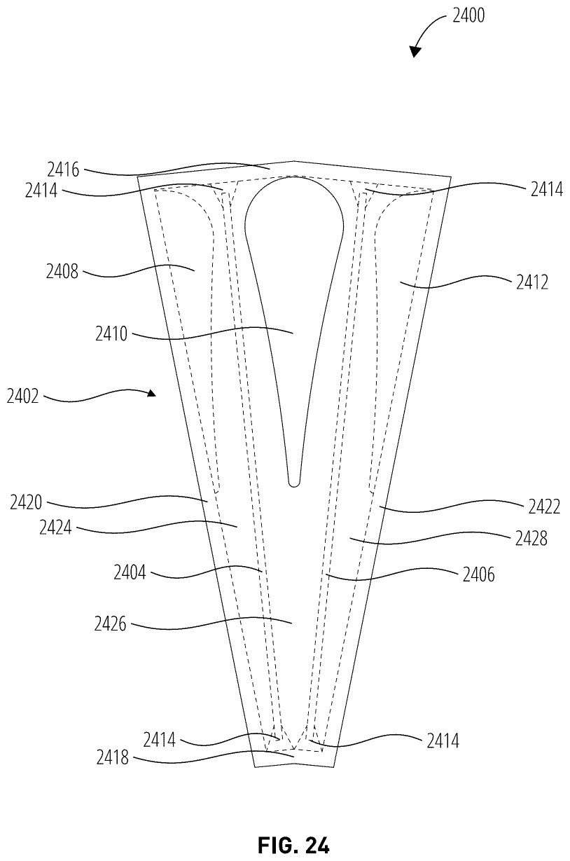

As shown in FIG. 24, and embodiment of a transducer element 2400, in a wedge shape, comprises an enclosure 2402, a first planar diaphragm 2404, a second planar diaphragm 2406, a first port 2408, a second port 2410, a third port 2412, a flexible compliant diaphragm attachment points 2414, a first frame end wall 2416, a second frame end wall 2418, a first frame side wall 2420, a second frame side wall 2422, a first acoustic chamber 2424, a second acoustic chamber 2426, and a third acoustic chamber 2428.

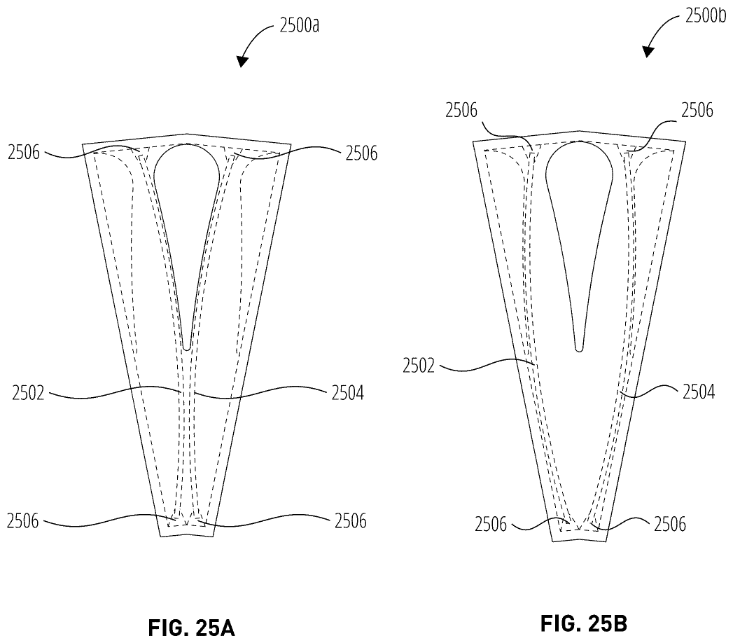

In addition to the features discussed above for the transducer element 2200, a transducer element 2400 may include a first planar diaphragm 2404 and a second planar diaphragm 2406, each with two flexible compliant diaphragm attachment points 2414. FIG. 24 to FIG. 25BB are transparent plan views with the top lid facing up and the bottom lid facing down. As illustrated in FIG. 24, some embodiments of the transducer element 2400 may also include a third port 2412. The second planar diaphragm 2406 may be configured within the frame where at least a portion of one end of the second planar diaphragm 2406 is coupled to an inner portion of the frame at a flexible compliant diaphragm attachment points 2414 that is perpendicular to the length of the enclosure and at an opposite end of the enclosure from flexible compliant diaphragm attachment points 2414 of the first planar diaphragm 2404. In an embodiment, the first and second planar diaphragms divide the depth of the enclosure to form the first acoustic chamber 2424, a second acoustic chamber 2426 and a third acoustic chamber 2428, where the second acoustic chamber 2426 is between the first and second planar diaphragms. In some embodiments, the first acoustic chamber 2424, a second acoustic chamber 2426 and a third acoustic chamber 2428 are mutually independent. In an illustrative embodiment, top lid is mounted perpendicular to the first and second planar diaphragms and includes a first port 2408 in fluid communication with the first acoustic chamber 2424 and a third port 2412 in fluid communication with the third acoustic chamber 2428. In some embodiments, the bottom lid is mounted perpendicular to the first and second planar diaphragms and includes a second port 2410 in fluid communication with the second acoustic chamber 2426. In some embodiments, the top lid and the bottom lid are separated by the depth of the frame.

In some embodiments, the plurality of walls includes a first frame end wall 2416, a first frame side wall 2420, a second frame end wall 2418, and a second frame side wall 2422. In an embodiment, at least a portion of one end of the first planar diaphragm 2404 and one end of the second planar diaphragm 2406 are each coupled, at a flexible compliant diaphragm attachment points 2414, to an inner portion of the frame that is perpendicular to the length of the enclosure and near the first frame end wall 2416, and in the direction from the first frame end wall 2416 towards the second frame end wall 2418. Additionally, at least a portion of the other end of the first planar diaphragm 2404 and the other end of the second planar diaphragm 2406 are each coupled, at a flexible compliant diaphragm attachment points 2414, near the second frame end wall 2418.

In an embodiment, FIG. 25A illustrates positive pressure displacement 2500a for the first planar diaphragm 2502 and the second planar diaphragm 2504. The maximum displacements of first planar diaphragm 2502 and second planar diaphragm 2504 toward each other are shown with first planar diaphragm attachment points at flexible compliant diaphragm attachment points 2506 and second planar diaphragm attachment points at flexible compliant diaphragm attachment points 2506.

In an embodiment, FIG. 25B illustrates negative pressure displacement 2500b for the first planar diaphragm 2502 and the second planar diaphragm 2504. The maximum displacements of first planar diaphragm 2502 and second planar diaphragm 2504 apart from each other are shown with first planar diaphragm attachment points at flexible compliant diaphragm attachment points 2506 and second planar diaphragm attachment points at flexible compliant diaphragm attachment points 2506.

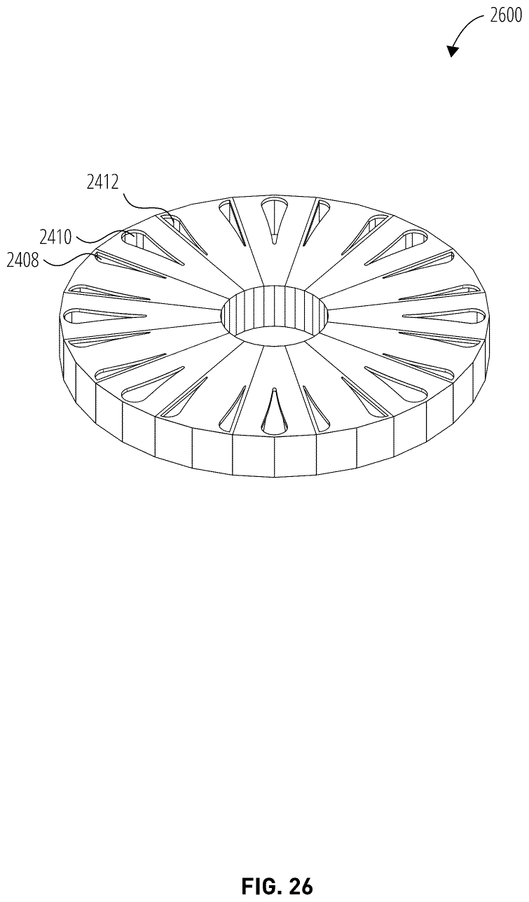

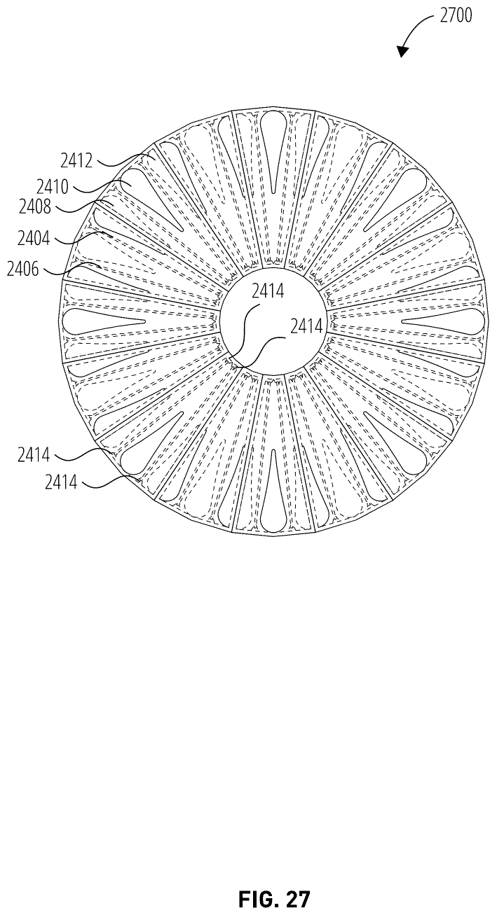

As illustrated in FIG. 26-FIG. 27, a circular array of transducer elements 2600 in a circular configuration comprises first planar diaphragms 2404, second planar diaphragms 2406, first ports 2408, second ports 2410, and third ports 2412. Each end of each planar diaphragm is coupled at flexible compliant diaphragm attachment points 2414. In some embodiments, first frame side walls 2420 of one transducer element are sequentially joined to second frame side walls 2422 of another transducer element.

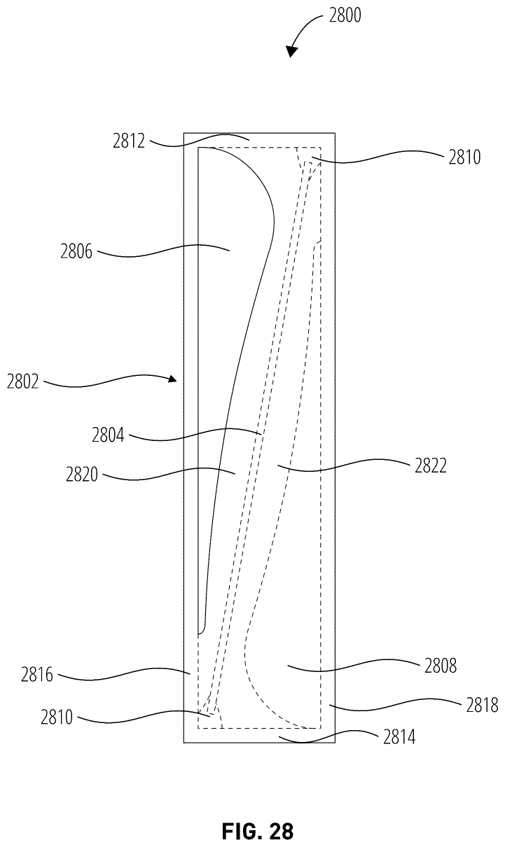

As shown in FIG. 28, a transducer element 2800 comprises an enclosure 2802, a planar diaphragm 2804, a first port 2806, a second port 2808, a flexible compliant diaphragm attachment point 2810, a first frame end wall 2812, a second frame end wall 2814, a first frame side wall 2816, a second frame side wall 2818, a first acoustic chamber 2820, and a second acoustic chamber 2822.

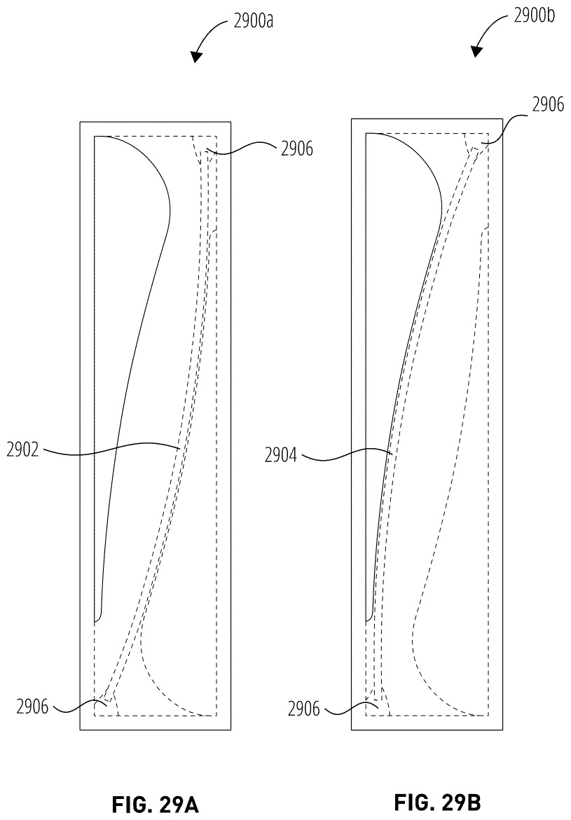

In addition to the features discussed above for the transducer element 2200, a transducer element 2800 may include a planar diaphragm 2804 and two flexible compliant diaphragm attachment points 2810, where the diaphragm attachment points are located in a first corner and a second corner of the frame. FIG. 28 to FIG. 29BB are transparent plan views with the top lid facing up and the bottom lid facing down. In some embodiments, as shown in FIG. 28 to FIG. 29B, a transducer element 2800 includes at least a portion of both ends of the planar diaphragm 2804 coupled to inner portions of the frame resulting in a diagonal planar diaphragm with respect to the length of the enclosure, connected by flexible compliant diaphragm attachment points 2810. In an illustrative embodiment, the first planar diaphragm is diagonally oriented within the frame, wherein the first end of the first planar diaphragm is coupled near a first corner formed by the first frame end wall 2812 and the first frame side wall 2816, and wherein the second end of the first planar diaphragm is coupled near a second corner formed by the second frame end wall 2814 and the second frame side wall 2818.

In an embodiment, FIG. 29A illustrates negative pressure displacement 2900a, specifically for a planar diaphragm in negative pressure displacement 2902 where the planar diaphragm is attached at each end with a flexible compliant diaphragm attachment, diagonally within the frame. The maximum negative displacement of the planar diaphragm in negative planar diaphragm in negative pressure displacement 2902 is shown with a flexible compliant diaphragm attachment point 2906 at each end while under negative displacement.

In an embodiment, FIG. 29B illustrates positive pressure displacement 2900b, specifically for a planar diaphragm with planar diaphragm in positive displacement 2904 where the planar diaphragm is attached at each end with a flexible compliant diaphragm attachment. The maximum positive displacement of the planar diaphragm in positive displacement 2904 is shown with a flexible compliant diaphragm attachment point 2906 at each end while under positive displacement.

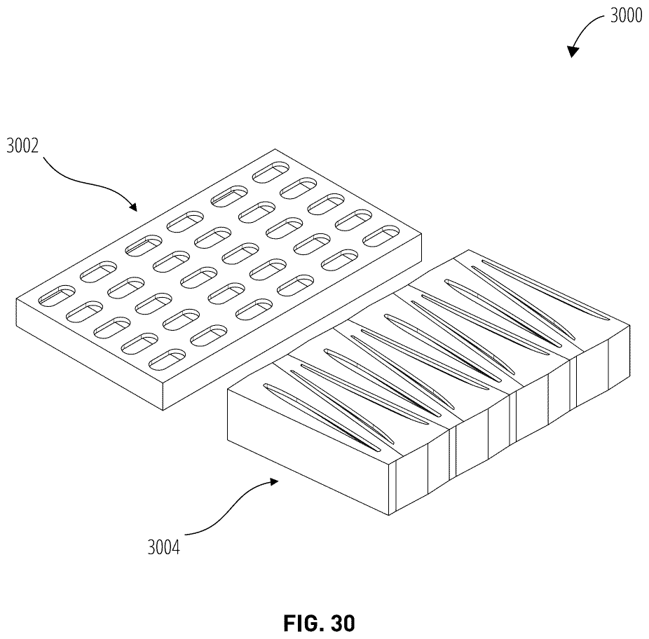

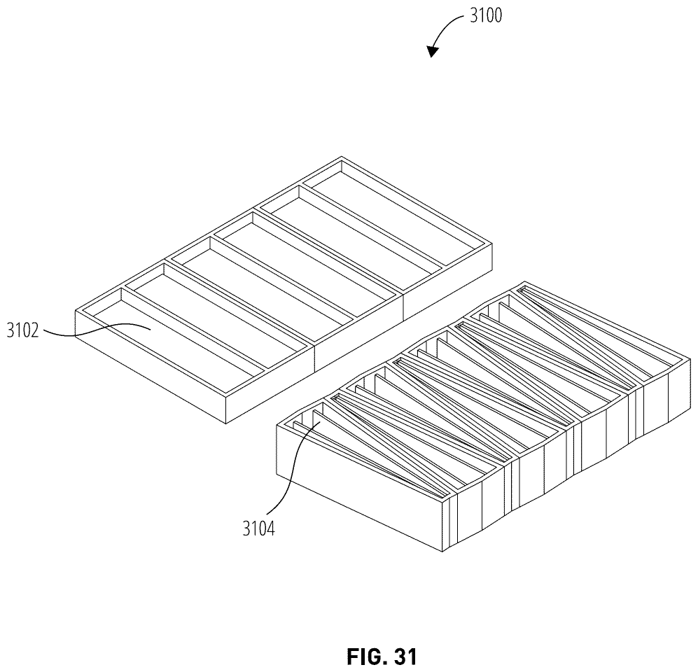

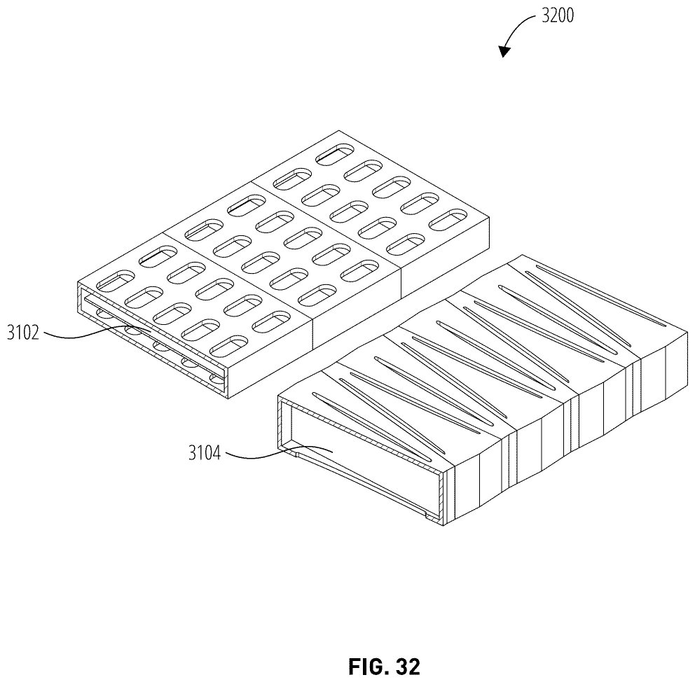

A linear array comparison to the prior art 3000 is shown in FIG. 30 to FIG. 32 between a prior art linear array 3002 located next to a disclosed linear array 3004 in accordance with the embodiments above. As shown by sectional views in FIG. 31 and FIG. 32, the prior art linear array 3002 is an array-type loudspeaker stacked transducer elements and prior art planar diaphragms 3102 that are singular for each transducer element. The diaphragms are also mounted such that they move parallelly to the vector of sound pressure output exiting the ports. By contrast, the disclosed linear array 3004 is an array-type loudspeaker that includes disclosed planar diaphragms 3104 with a plurality of diaphragms in each transducer element. The diaphragms are mounted such that they move orthogonally to the vector of sound pressure output exiting the ports. As mentioned above, this configuration may reduce the occupied footprint of the stacked loudspeaker units and/or may significantly increase the sound pressure level of the array-type loudspeaker for a given footprint, as compared to the prior art. One of skill in the art will appreciate that speakers with Orthogonal Diaphragm Motion, with a direct radiator diaphragm, may increase the air volume displacement for a given enclosure footprint.

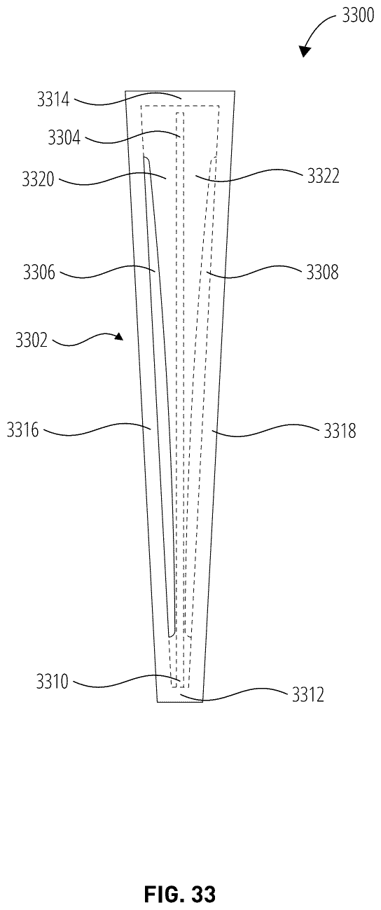

As shown in FIG. 33, some embodiments of a transducer element 3300 comprise an enclosure 3302, a planar diaphragm 3304, a first port 3306, a second port 3308, a diaphragm attachment point 3310, a first frame end wall 3312, a second frame end wall 3314, a first frame side wall 3316, a second frame side wall 3318, a first acoustic chamber 3320, and a second acoustic chamber 3322.

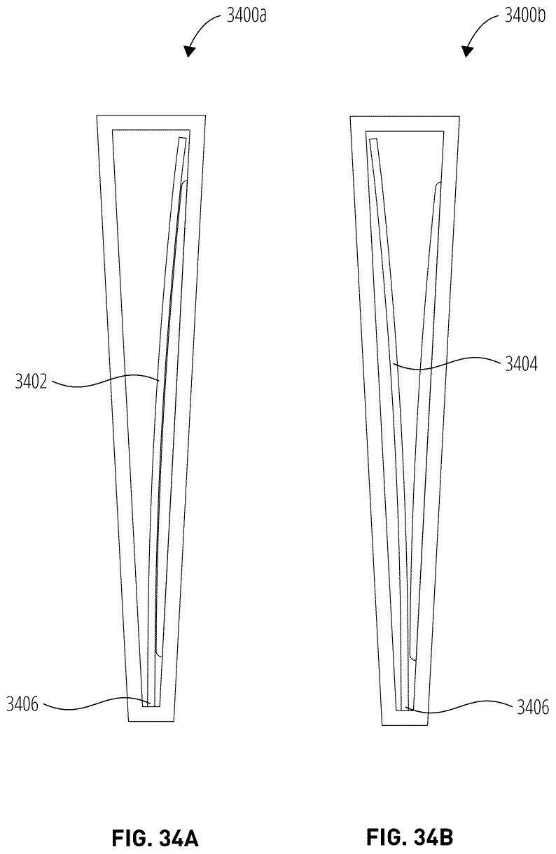

In some embodiments, as shown in FIG. 33 to FIG. 34B, a transducer element 3300 in a wedge shape includes an enclosure 3302 comprising a multi-walled frame, a plurality of walls arranged to form the multi-walled frame, a top lid and a bottom lid, where the enclosure 3302 has a width, a depth, and a length. FIG. 33 is a transparent plan view with the top lid facing up and the bottom lid facing down. FIG. 34A and FIG. 34B are plan views with the top lids removed and the bottom lids facing down. The transducer element also includes at least one planar diaphragm including a first planar diaphragm 3304, where the at least one planar diaphragm is configured within the frame to move orthogonally with respect to a normal vector of sound pressure output exiting a first port 3306 and exiting a second port 3308 in an opposite phase. In some embodiments, at least a portion of at least one end of the at least one planar diaphragm 3304 is coupled to an inner portion of the frame that is perpendicular to the length of the enclosure as seen in diaphragm attachment point 3310. In an illustrative embodiment, the at least one planar diaphragm divides the depth of the enclosure to form a first acoustic chamber 3320 and a second acoustic chamber 3322, the first acoustic chamber and the second acoustic chamber being mutually independent. In some embodiments, the top lid is mounted perpendicular to the planar diaphragm 3304 and includes the first port 3306 in fluid communication with the first acoustic chamber 3320. Additionally, the bottom lid may be mounted perpendicular to the planar diaphragm 3304 and includes the second port 3308 in fluid communication with the second acoustic chamber 3322. Further, the top lid and the bottom lid are separated by the depth of the frame.

In some embodiments, the plurality of walls may include a first frame end wall 3312, a first frame side wall 3316, a second frame end wall 3314, and a second frame side wall 3318. Additionally, at least a portion of at least one end of the first planar diaphragm 3304 may be coupled to an inner portion of the frame that is perpendicular to the length of the enclosure and near the first frame end wall 3312, and in a direction from the first frame end wall 3312 towards the second frame end wall 3314.

In an embodiment, FIG. 34A illustrates negative pressure displacement 3400a, specifically for a planar diaphragm with the planar diaphragm in negative displacement 3402. The maximum negative displacement of the planar diaphragm in negative displacement 3402 is shown with a diaphragm attachment point 3406

In an embodiment, FIG. 34B illustrates positive pressure displacement 3400b, specifically for a planar diaphragm with the planar diaphragm in positive displacement 3404. The maximum positive displacement of the planar diaphragm in positive displacement 3404 is shown with a diaphragm attachment point 3406.

As shown in FIG. 35, a transducer element 3500 comprises an enclosure 3502, a first planar diaphragm 3504, a second planar diaphragm 3506, a first port 3508, a second port 3510, a third port 3512, a diaphragm attachment point 3514, a first frame end wall 3516, a second frame end wall 3518, a first frame side wall 3520, a second frame side wall 3522, a first acoustic chamber 3524, a second acoustic chamber 3526, and a third acoustic chamber 3528.

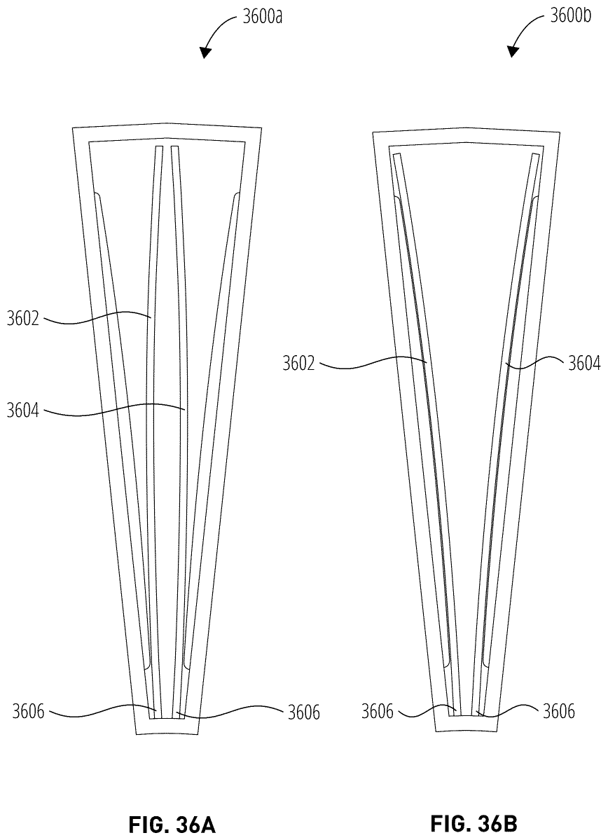

In addition to the features discussed above for the transducer element 1300, a transducer element 3500 in a wedge shape may include a second planar diaphragm 3506. FIG. 35 is a transparent plan view with the top lid facing up and the bottom lid facing down. FIG. 36A and FIG. 36B are plan views with the top lids removed and the bottom lids facing down. As illustrated in FIG. 13, some embodiments of the audio speaker transducer element 3500 may also include a second planar diaphragm 3506 and a third port 3512. The second planar diaphragm 3506 may be configured within the frame where at least a portion of at least one end of the second planar diaphragm is coupled to an inner portion of the frame at a second diaphragm attachment point 3514 that is perpendicular to the length of the enclosure and at the same end of the enclosure from a first diaphragm attachment point 3514. In an embodiment, the first and second planar diaphragms divide the depth of the enclosure to form the first acoustic chamber 3524, the third acoustic chamber 3528, and a second acoustic chamber 3526 between the first and second planar diaphragms. In some embodiments, the first acoustic chamber 3524, third acoustic chamber 3528, and second acoustic chamber 3526 being mutually independent. In an illustrative embodiment, the top lid is mounted perpendicular to the first and second planar diaphragms and includes a first port 3508 in fluid communication with the first acoustic chamber 3524 and a third port 3512 in fluid communication with the third acoustic chamber 3528. In some embodiments, the bottom lid is mounted perpendicular to the first and second planar diaphragms and includes a second port 3510 in fluid communication with the second acoustic chamber 3526. In some embodiments, the top lid and the bottom lid are separated by the depth of the frame.

In some embodiments, the plurality of walls includes a first frame end wall 3516, a first frame side wall 3520, a second frame end wall 3518, and a second frame side wall 3522. In an embodiment, at least a portion of at least one end of the first planar diaphragm 3504 is coupled to an inner portion of the frame that is perpendicular to the length of the enclosure and near the first frame end wall 3516, and in the direction from the first frame end wall 3516 towards the second frame end wall 3518. Additionally, at least a portion of at least one end of the second planar diaphragm 3506 may be coupled to an inner portion of the frame that is perpendicular to the length of the enclosure and also near the first frame end wall 3516 and in the direction from the first frame end wall 3516 towards the second frame end wall 3518.

In an embodiment, the first frame end walls 3516 and the second frame end walls 3518 of the transducer element 3500 are different heights in the width dimension of the enclosure, thereby forming a wedge-shaped transducer element.

In an embodiment, FIG. 36A illustrates positive pressure displacement 3600a for the first planar diaphragm 3602 and the second planar diaphragm 3604. The maximum displacements of first planar diaphragm 3602 and second planar diaphragm 3604 toward each other are shown with first planar diaphragm attachment point at diaphragm attachment points 3606 and second planar diaphragm attachment point at diaphragm attachment points 3606.

In an embodiment, FIG. 36B illustrates negative pressure displacement 3600b for the first planar diaphragm 3602 and the second planar diaphragm 3604. The maximum displacements of first planar diaphragm 3602 and second planar diaphragm 3604 apart from each other are shown with first planar diaphragm attachment point at diaphragm attachment points 3606 and second planar diaphragm attachment point at diaphragm attachment points 3606.

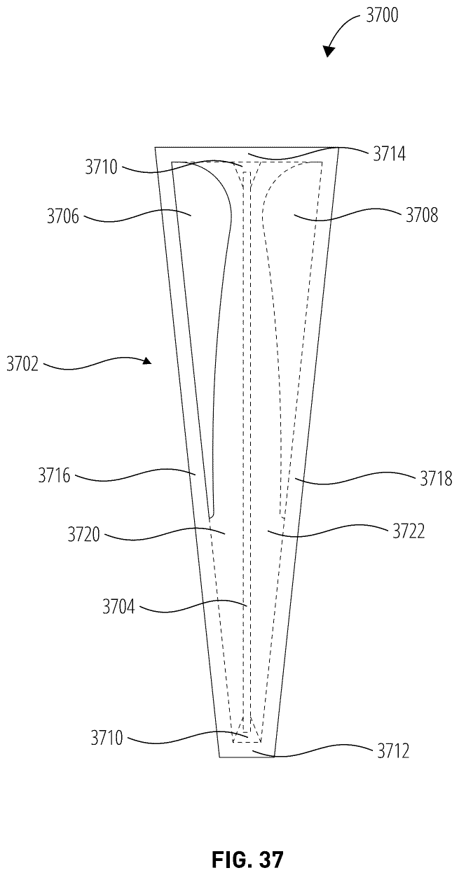

As shown in FIG. 37, some embodiments of a transducer element 3700 comprises an enclosure 3702, a planar diaphragm 3704, a first port 3706, a second port 3708, a flexible compliant diaphragm attachment point 3710, a first frame end wall 3712, a second frame end wall 3714, a first frame side wall 3716, a second frame side wall 3718, a first acoustic chamber 3720, and a second acoustic chamber 3722.

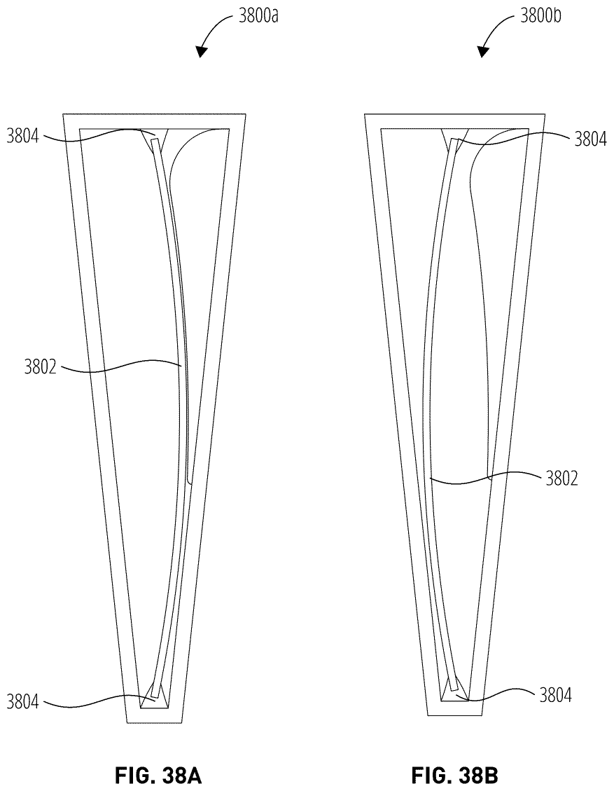

In addition to the features discussed above for the transducer element 2200, a transducer element 3700 in a wedge shape may include a planar diaphragm 3704 and two flexible compliant diaphragm attachment points 3710. FIG. 37 is a transparent plan view with the top lid facing up and the bottom lid facing down. FIG. 38A and FIG. 38B are plan views with the top lids removed and the bottom lids facing down. FIG. 37 to FIG. 38B are transparent plan views with the top lid facing up and the bottom lid facing down. In some embodiments, as shown in FIG. 37 to FIG. 38B, a transducer element 3700 includes at least a portion of both ends of the planar diaphragm 3704 coupled to an inner portion of the frame that is perpendicular to the length of the enclosure as seen in flexible compliant diaphragm attachment points 3710. In an illustrative embodiment, this planar diaphragm 3704 divides the depth of the enclosure to form a first acoustic chamber 3720 and a second acoustic chamber 3722, the first acoustic chamber and the second acoustic chamber being mutually independent. In some embodiments, a top lid is mounted perpendicular to the planar diaphragm 3704 and includes the first port 3706 in fluid communication with the first acoustic chamber 3720. Additionally, the bottom lid may be mounted perpendicular to the planar diaphragm 3704 and includes the second port 3708 in fluid communication with the second acoustic chamber 3722. Further, the top lid and the bottom lid are separated by the depth of the frame.

In some embodiments, a plurality of walls may include a first frame end wall 3712, a first frame side wall 3716, a second frame end wall 3714, and a second frame side wall 3718. Additionally, at least a portion of one end of the planar diaphragm 3704 may be coupled to an inner portion of the frame that is perpendicular to the length of the enclosure and near the first frame end wall 3712, and at least a portion of the other end of the planar diaphragm 3704 may be coupled to an inner portion of the frame that is perpendicular to the length of the enclosure and near the first second frame end wall 3714.

In an embodiment, FIG. 38A illustrates negative pressure displacement 3800a, specifically for a planar diaphragm in negative pressure displacement 3800a where the planar diaphragm is attached at each end with a flexible compliant diaphragm attachment. The maximum negative displacement of the planar diaphragm 3802 in negative displacement is shown with a flexible compliant diaphragm attachment points 3804 at each end while under negative displacement.

In an embodiment, FIG. 38B illustrates positive pressure displacement 3800b, specifically for a planar diaphragm with planar diaphragm in positive pressure displacement 3800b where the planar diaphragm is attached at each end with a flexible compliant diaphragm attachment. The maximum positive displacement of the planar diaphragm 3802 in positive displacement is shown with a flexible compliant diaphragm attachment points 3804 at each end while under positive displacement.

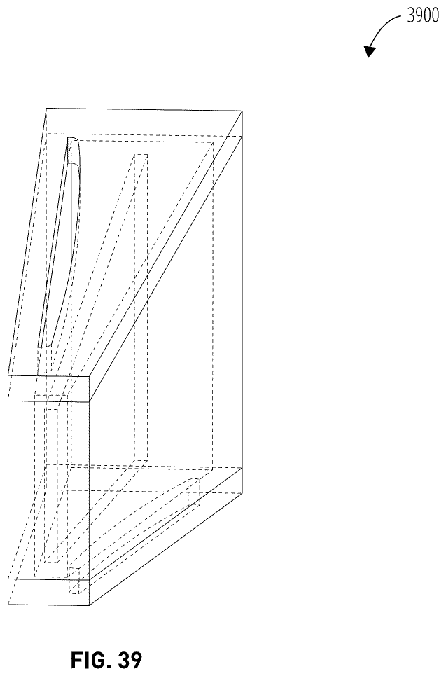

As seen in FIG. 39, in some embodiments a transducer element 3900 displays a planar diaphragm shape and an accompanying enclosure profile, demonstrating that the transducer elements are not limited to being formed by all right angles. In some embodiments, a non-rectangular planar diaphragm (along with the appropriate enclosure) may be applied to the transducer element embodiments above. In exemplary embodiments, the top and bottom edges of the planar diaphragms do not need to be straight lines. They may be curved, and the lids may be curved appropriately.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the terms “first,” “second,” etc. are used as labels for nouns that they precede and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

Terms used herein may be accorded their ordinary meaning in the relevant arts, or the meaning indicated by their use in context, but if an express definition is provided, that meaning controls.

“Near” is used to convey a distance and may be substituted with “in close proximity to.”

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

What is claimed is:

1. A transducer element comprising:
an enclosure including:
a multi-walled frame;
a plurality of walls arranged to form the multi-walled frame, the plurality of walls including a top lid and a bottom lid, wherein the enclosure has a width, a depth, and a length; and
at least one planar diaphragm including a first planar diaphragm comprising a first end and a second end;
wherein the at least one planar diaphragm is configured within the multi-walled frame to move substantially orthogonally with respect to a normal vector of sound pressure output exiting a first port and exiting a second port in an opposite phase;
wherein at least a portion of the first end of the at least one planar diaphragm is coupled to an inner portion of the multi-walled frame that is substantially perpendicular to the length of the enclosure;
wherein the at least one planar diaphragm divides the width of the enclosure to form a first acoustic chamber and a second acoustic chamber, the first acoustic chamber and the second acoustic chamber being mutually independent;
wherein the top lid is mounted perpendicular to the first planar diaphragm and includes the first port in fluid communication with the first acoustic chamber, and the bottom lid is mounted perpendicular to the first planar diaphragm and includes the second port in fluid communication with the second acoustic chamber; and
wherein the top lid and the bottom lid are separated by the depth of the multi-walled frame.

2. The transducer element of claim 1, wherein the plurality of walls include a first frame end wall, a first frame side wall, a second frame end wall, and a second frame side wall; and
wherein at least a portion of the first end of the first planar diaphragm is coupled to an inner portion of the multi-walled frame that is perpendicular to the length of the enclosure and near the first frame end wall, and in a direction from the first frame end wall towards the second frame end wall.

3. The transducer element of claim 2, wherein the first frame end walls and the second frame end walls of the transducer element are different heights in the depth dimension of the enclosure, thereby forming a wedge shaped transducer element.

4. The transducer element of claim 2, wherein the first frame end walls and the second frame end walls of the transducer element are different heights in the width dimension of the enclosure, thereby forming a wedge shaped transducer element.

5. The transducer element of claim 2, wherein the first frame end walls and the second frame end walls of the transducer element are different heights in both the width dimension and the depth dimension of the enclosure, thereby forming a double wedge shaped transducer element.

6. The transducer element of claim 2, wherein at least a portion of the second end of the first planar diaphragm is coupled to an inner portion of the multi-walled frame that is perpendicular to the length of the enclosure and near the second frame end wall, and wherein each of the first end and the second end is compliantly coupled to the multi-walled frame to function as a hinge.

7. The transducer element of claim 6, wherein the first planar diaphragm is diagonally oriented within the multi-walled frame,
wherein the first end of the first planar diaphragm is coupled near a first corner formed by the first frame end wall and the first frame side wall, and
wherein the second end of the first planar diaphragm is coupled near a second corner formed by the second frame end wall and the second frame side wall.

8. The transducer element of claim 2, wherein a preset gap not exceeding five percent of the width of the first planar diaphragm exists in at least one of the following:
between the first planar diaphragm and the second frame end wall;
between the first planar diaphragm and the top lid; and
between the first planar diaphragm and the bottom lid.

9. The transducer element of claim 2, wherein a preset gap is a flexible compliant surround material.

10. The transducer element of claim 2, the first planar diaphragm further comprising a flexible suspension edge;
wherein at least one of:
the first planar diaphragm is connected to the second frame end wall via the flexible suspension edge;
the first planar diaphragm is connected to the top lid via the flexible suspension edge; and
the first planar diaphragm is connected to the bottom lid via the flexible suspension edge.

11. The transducer element of claim 2, the transducer element including a first transducer element and further comprising at least one additional transducer element with the same configuration as the first transducer element, wherein the first frame end walls and the second frame end walls of the first transducer element and the at least one additional transducer element are sequentially fixedly connected along an edge of the first frame end walls and an edge of the second frame end walls.

12. The transducer element of claim 2, the transducer element including a first transducer element and further comprising a plurality of additional transducer elements with the same configuration as the first transducer element, wherein the first frame end walls and the second frame end walls of the first transducer element and the plurality of additional transducer elements are sequentially fixedly connected along an edge of the first frame end walls and an edge of the second frame end walls, resulting in a circular array of transducer elements.

13. The transducer element of claim 1, wherein the first planar diaphragm is a piezoelectric bimorph.

14. The transducer element of claim 1, further comprising a second planar diaphragm and a third port;
wherein the second planar diaphragm is configured within the multi-walled frame and comprises a third end and a fourth end;
wherein at least a portion of the third end of the second planar diaphragm is coupled to an inner portion of the multi-walled frame that is perpendicular to the length of the enclosure and at an opposite end of the enclosure;
wherein the first and second planar diaphragms divide the width of the enclosure to form the first acoustic chamber, the second acoustic chamber between the first and second planar diaphragms, and a third acoustic chamber, the first, second and third acoustic chambers being mutually independent;
wherein the top lid is mounted perpendicular to the first and second planar diaphragms and includes the first port in fluid communication with the first acoustic chamber and the third port in fluid communication with the third acoustic chamber, and the bottom lid is mounted perpendicular to the first and second planar diaphragms and includes the second port in fluid communication with the second acoustic chamber; and
wherein the top lid and the bottom lid are separated by the depth of the multi-walled frame.

15. The transducer element of claim 1, further comprising a second planar diaphragm and a third port;
wherein the second planar diaphragm is configured within the multi-walled frame and comprises a third end and a fourth end;
wherein at least a portion of the third end of the second planar diaphragm is coupled to an inner portion of the multi-walled frame that is perpendicular to the length of the enclosure and at the same end of the enclosure as the first end;
wherein the first and second planar diaphragms divide the width of the enclosure to form the first acoustic chamber, the second acoustic chamber between the first and second planar diaphragms, and a third acoustic chamber, the first, second and third acoustic chambers being mutually independent;
wherein the top lid is mounted perpendicular to the first and second planar diaphragms and includes the first port in fluid communication with the first acoustic chamber and the third port in fluid communication with the third acoustic chamber, and the bottom lid is mounted perpendicular to the first and second planar diaphragms and includes the second port in fluid communication with the second acoustic chamber; and
wherein the top lid and the bottom lid are separated by the depth of the multi-walled frame.

16. The transducer element of claim 14, wherein the plurality of walls include a first frame end wall, a first frame side wall, a second frame end wall, and a second frame side wall;
wherein at least a portion of the first end of the first planar diaphragm is coupled to an inner portion of the multi-walled frame that is perpendicular to the length of the enclosure and near the first frame end wall, and in the direction from the first frame end wall towards the second frame end wall; and
wherein at least a portion of the third end of the second planar diaphragm is coupled to an inner portion of the multi-walled frame that is perpendicular to the length of the enclosure and near the second frame end wall and in the direction from the second frame end wall towards the first frame end wall.

17. The transducer element of claim 16, wherein at least a portion of the second end of the first planar diaphragm is coupled to an inner portion of the multi-walled frame that is perpendicular to the length of the enclosure and near the second frame end wall;
wherein at least a portion of the fourth end of the second planar diaphragm is coupled to an inner portion of the multi-walled frame that is perpendicular to the length of the enclosure and near the first frame end wall; and
wherein each of the first end, the second end, the third end, and the fourth end is compliantly coupled to the multi-walled frame to function as a hinge.

18. The transducer element of claim 16, wherein a preset gap not exceeding five percent of the width of the second planar diaphragm exists in at least one of the following:
between the second planar diaphragm and the first frame end wall;
between the second planar diaphragm and the top lid; and
between the second planar diaphragm and the bottom lid.

19. The transducer element of claim 16, wherein the first frame end walls and the second frame end walls of the transducer element are different heights in the width dimension of the enclosure, thereby forming a wedge shaped transducer element.

20. The transducer element of claim 1, wherein the first planar diaphragm includes at least one of:
an electromechanical layer;
a magnetostrictive layer; and
an electrostrictive layer.

21. The transducer element of claim 14, the transducer element including a first transducer element and further comprising at least one additional transducer element with the same configuration as the first transducer element, wherein the first frame end walls and the second frame end walls of the first transducer element and the at least one additional transducer element are sequentially fixedly connected along an edge of the first frame end walls and an edge of the second frame end walls.

22. A transducer, comprising: a plurality of transducer elements, wherein each transducer element comprises:
an enclosure including:
a multi-walled frame;
a plurality of walls arranged to form the multi-walled frame, the plurality of walls including a top lid and a bottom lid, wherein the enclosure has a width, a depth, and a length; and
at least one planar diaphragm including a first planar diaphragm comprising a first end and a second end;
wherein the at least one planar diaphragm is configured within the multi-walled frame to move substantially orthogonally with respect to a normal vector of sound pressure output exiting a first port and exiting a second port in an opposite phase;
wherein at least a portion of the first end of the at least one planar diaphragm is coupled to an inner portion of the multi-walled frame that is substantially perpendicular to the length of the enclosure;
wherein the at least one planar diaphragm divides the width of the enclosure to form a first acoustic chamber and a second acoustic chamber, the first acoustic chamber and the second acoustic chamber being mutually independent;
wherein the top lid is mounted perpendicular to the first planar diaphragm and includes the first port in fluid communication with the first acoustic chamber, and the bottom lid is mounted perpendicular to the first planar diaphragm and includes the second port in fluid communication with the second acoustic chamber; and
wherein the top lid and the bottom lid are separated by the depth of the multi-walled frame.

23. The transducer of claim 22, wherein the plurality of walls include a first frame end wall, a first frame side wall, a second frame end wall, and a second frame side wall; and
wherein at least a portion of the first end of the first planar diaphragm is coupled to an inner portion of the multi-walled frame that is perpendicular to the length of the enclosure and near the first frame end wall, and in a direction from the first frame end wall towards the second frame end wall.

24. The transducer of claim 23, the transducer element including a first transducer element and further comprising at least one additional transducer element with the same configuration as the first transducer element, wherein the first frame end walls and the second frame end walls of the first transducer element and the at least one additional transducer element are sequentially fixedly connected along an edge of the first frame end walls and an edge of the second frame end walls.

25. The transducer of claim 23, the transducer element including a first transducer element and further comprising a plurality of additional transducer elements with the same configuration as the first transducer element, wherein the first frame end walls and the second frame end walls of the first transducer element and the plurality of additional transducer elements are sequentially fixedly connected along an edge of the first frame end walls and an edge of the second frame end walls, resulting in the transducer having the shape of a circular array.

26. The transducer of claim 23, wherein the first frame end walls and the second frame end walls of the transducer elements are different heights in the width dimension of the enclosure, thereby forming wedge shaped transducer elements.

27. The transducer of claim 22, further comprising a second planar diaphragm and a third port;
wherein the second planar diaphragm is configured within the multi-walled frame and comprises a third end and a fourth end;
wherein at least a portion of the third end of the second planar diaphragm is coupled to an inner portion of the multi-walled frame that is perpendicular to the length of the enclosure and at an opposite end of the enclosure;
wherein the first and second planar diaphragms divide the width of the enclosure to form the first acoustic chamber, the second acoustic chamber between the first and second planar diaphragms, and a third acoustic chamber, the first, second and third acoustic chambers being mutually independent;
wherein the top lid is mounted perpendicular to the first and second planar diaphragms and includes the first port in fluid communication with the first acoustic chamber and the third port in fluid communication with the third acoustic chamber, and the bottom lid is mounted perpendicular to the first and second planar diaphragms and includes the second port in fluid communication with the second acoustic chamber; and
wherein the top lid and the bottom lid are separated by the depth of the multi-walled frame.
